(19) United States
(12) Patent Application Publication
(10) Pub. No.: US 2026/0186828 A1
(43) Pub. Date: Jul. 2, 2026

(54) CROSS-AGENT CONTEXT MANAGEMENT FOR MULTI-AGENT SYSTEM

(71) Applicant: Microsoft Technology Licensing, LLC, Redmond, WA (US)

(72) Inventors: Juan Pablo Bottaro, Madrid (ES); Gokulraj Mohanasundaram, Fremont, CA (US); Keren Baruch, West Orange, NJ (US); Kevin Arcara, Tarrytown, NY (US); Amol Chandla, San Francisco, CA (US); Vivek Katarya, San Jose, CA (US); Christopher Ng, Chappaqua, NY (US); David Nicolas Racca, Lecco (IT); Santhosh Sachindran, Campbell, CA (US); Jeffrey Wang, San Francisco, CA (US)

(21) Appl. No.: 19/005,391

(22) Filed: Dec. 30, 2024

(51) Int. Cl. G06F 9/48

(52) U.S. Cl. CPC G06F 9/4881; G06F 2209/482; G06F 2209/486

(57) ABSTRACT

An example maps input to a first task executable by a first task agent of a multi-agent application system. A search is formulated using the input and the first task. The search is executed on a second layer of a multi-layer memory accessible to the orchestrator agent. First cross-agent context data related to the input and the first task is extracted from results of the search. The first task and the first cross-agent context data are routed to the first task agent. Output is received from the first task agent. The output is generated via execution of the first task by the first task agent using the first cross-agent context data. A response to the input is provided. The response includes the output generated by the first task agent using the first cross-agent context data generated by the second task agent.

### TECHNICAL FIELD

Technical fields to which this disclosure relates include artificial intelligence-based agents.

### COPYRIGHT NOTICE

This patent document, including the accompanying drawings, contains material that is subject to copyright protection. The copyright owner has no objection to the facsimile reproduction of this patent document, as it appears in the publicly accessible records of the United States Patent and Trademark Office, consistent with the fair use principles of the United States copyright laws, but otherwise reserves all copyright rights whatsoever.

### BACKGROUND

In computers, an agent is a software component designed to perform a task autonomously or semi-autonomously on behalf of a user or another entity based on a goal or objective. An agent may use machine learning models to interact with an environment, collect and evaluate data, and perform tasks without human intervention.

### BRIEF DESCRIPTION OF THE DRAWINGS

The disclosure will be understood more fully from the detailed description given below and from the accompanying drawings of various examples of the disclosure. The drawings are for explanation and understanding only and should not be taken to limit the disclosure to the specific examples shown.

FIG. 1 is a component-based flow diagram of an example method for multi-agent management in a multi-agent system in accordance with some examples of the present disclosure.

FIG. 2 is a component-based flow diagram of an example method for cross-agent context management in a multi-agent system in accordance with some examples of the present disclosure.

FIG. 3 is a component-based flow diagram of an example method for cross-agent event management in a multi-agent system in accordance with some examples of the present disclosure.

FIG. 4, FIG. 5, and FIG. 6 are screen captures of example user interface displays in accordance with some examples of the present disclosure.

FIG. 7 is a flow diagram of an example method for cross-agent management in accordance with some examples of the present disclosure.

FIG. 8 is a block diagram of a computing system that includes an agent system in accordance with some examples of the present disclosure.

FIG. 9A, FIG. 9B, FIG. 9C, FIG. 9D, and FIG. 9E are block diagrams of examples of machine learning models that are usable by and/or included in an agent system in accordance with some examples of the present disclosure.

FIG. 10 is a block diagram of an example computer system including components of an agent system in accordance with some examples of the present disclosure.

### DETAILED DESCRIPTION

In computer software, “pull” often refers to a process of retrieving and providing data to a device in response to an input, such as signal, query, or request received from an entity via a software application. With pull-based services, the objective is often to optimize the retrieved data for responsiveness to the input that has been received from the associated entity. Examples of entities include users, companies, organizations, institutions, associations, cohorts, or groups of entities. Other examples of entities include devices, networks, computer systems, hardware and/or software components, machine learning models, or agents. Still other examples of entities include physical devices such as sensors, robots, appliances, or vehicles. Entities are not limited to these examples. Aspects of any examples that are described referencing users are applicable to other types of entities in other examples.

The term “push” often refers to a system's ability to send data, such as signals, notifications, messages, recommendations, or content items, to a device associated with an entity in the absence of a specific request for that data. With push-based services, information is proactively provided or made accessible to the entity rather than in response to a signal, query, or request. Thus, with push-based services, the goal is often to optimize push communications for responsiveness to a current state of a software application with respect to an entity that is the target of the push communications.

Context data is sometimes used to try to improve push- and/or pull-based services. In pull-based services, context data is sometimes used to supplement the received input with information about the associated entity. In push-based services, context data is sometimes used to determine the current application state with respect to the target entity in the absence of input. Examples of context data include data that is directly or indirectly associated with an entity, such as metadata and interaction logs.

A multi-application system includes multiple different software applications arranged within a single framework to provide various functionalities via the framework. An example of a multi-application system is an online platform that includes multiple different but related user-facing capabilities, such as a push-based content feed, a pull-based search engine, an asynchronous messaging system, and a push-based recommendation system. Another example of a multi-application system is a complex physical system that has multiple independently operable but interconnected subsystems, such as a robot, vehicle, or computer network.

Agent refers to a semi-autonomous or autonomous software system that is able to consume information and/or signals from its environment, execute logic, reasoning, and learning processes, and perform actions to achieve a specific goal or set of goals with minimal human guidance or intervention. In some examples, agents have multiple levels of autonomy. Some agents have the capacity to perform tasks requiring complex understanding, reasoning, learning, and adaptability. Some agents are capable of processing and interpreting natural language and/or multimodal digital content, determining relevant context, formulating plans, and learning from interactions or data inputs. Some agents dynamically adapt their processing capabilities in response to changing environments, inputs, or goals. Some agents are capable of interacting with human users and other systems, including other agents or groups of agents. Unlike simpler automated systems, agents are data-driven and are capable of utilizing machine learning and/or deep learning techniques to improve their performance over time, making them suitable for a wide range of search applications.

Attempts have been made to use machine learning-based agents to perform various functionalities of multi-application systems. However, agents are often designed to perform discrete, non-overlapping tasks due to efficiency, performance, reliability, resource utilization, security, and/or other considerations. Although task outputs sometimes may be shared between agents, the intermediate context data developed by one agent in the course of executing a task has not been shared with other agents designed to perform other tasks. Thus, a technical challenge is to enable selective sharing of context data across task-specific agents of a multi-agent system. Another technical challenge is to effectively and reliably manage the cross-agent sharing of context data to ensure that efficiency, performance, reliability, resource utilization, data security, and/or other considerations are met.

A technical solution described herein is to provide an orchestrator agent of a multi-agent system with its own memory, which stores cross-agent context data, and tools to manage the flow of cross-agent context data into and out of the orchestrator-level memory. The orchestrator agent uses the tools to selectively communicate the cross-agent context data to task agents of the multi-agent system. In comparison to task-specific context data, cross-agent context data includes information about multiple different tasks performed by multiple different task-specific agents, including historical interaction and/or task execution information that evidences patterns and/or trends of use of task agents. An example of a pattern is a repeating sequence of calls to specific task agents, e.g., a first task agent is often called prior to a second task agent, etc. An example of a trend is a change in use of task agents, e.g., for the last six months a first task agent has been used more frequently than a second task agent; or, for the last 30 days a third task agent has been used more frequently than the first task agent or the second task agent.

In some examples, the orchestrator-level memory is a multi-layer memory. In some examples, the multi-layer memory includes a first layer and a second layer, where the first layer functions as interaction memory and the second layer functions as experiential memory. The interaction memory stores communications between the orchestrator agent and the various task agents (e.g., raw communications such as messages and message threads).

Communications between the orchestrator agent and task agents are captured and stored in the interaction memory as they occur, e.g., in real time. The experiential memory is updated through a different process that periodically creates machine learning-based representations of information stored in the interaction memory (e.g., a nearline process). The machine learning-based representations facilitate efficient search and retrieval of cross-agent context data using techniques such as embedding-based retrieval (EBR), retrieval-augmented generation (RAG), semantic search, and others.

In some examples, the interaction memory is used to provide first-level cross-agent context data to the orchestrator agent, which the orchestrator agent uses to perform a first, e.g., cross-agent, level of intent classification. The orchestrator agent maps the intent classification to a task agent. In some examples, once a task agent is identified that maps to the first-level intent classification, the orchestrator agent obtains second-level cross-agent context data from the interaction memory.

The second-level cross-agent context data corresponds to the task to be performed by the identified task agent. The orchestrator agent provides the second-level cross-agent context data to the task agent for use in performing its respective task. In some examples, the task agent uses the second-level cross-agent context to perform a second level, e.g., task-specific, intent classification. Benefits of the described solutions include that cross-agent context data is available for first-level intent classification and task agent mapping at the orchestrator agent, and that cross-agent context data is available for second-level intent classification and task execution at the task agents.

Another technical challenge is how to improve the efficiency of push notifications in a multi-agent system. A technical solution described herein is to use an orchestrator agent to perform and manage event listening and selectively map events to task agents of the multi-agent system. Benefits of the described solution include cross-agent coordination of push communications and reductions in the number of push communications received by entities from the multi-agent system. In examples where users receive the push communications, another potential benefit is a reduction in the burden of input by the user. For instance, selective management of push communications by the orchestrator agent removes the need for the user to explicitly request those communications and also reduces the need for the user to dismiss or delete numerous push communications.

Additionally, the ability to manage push notifications based on cross-agent context reduces the burden of input on the user because the system does not need to ask the user to provide the context already learned via other task agents. Therefore, the system is able to obtain useful context without requiring the user to provide that context via input. In these and other ways, the described solution is capable of optimizing system resources such as memory, processor utilization, load balancing, network bandwidth, and others due to reductions in the number of calls between the user and the multi-agent system.

The disclosure will be understood more fully from the detailed description given below, which references the accompanying drawings. The detailed description of the drawings is for explanation and understanding, and should not be taken to limit the disclosure to the specific examples described. In some examples, components with the same name but different reference numbers in different figures have the same or similar functionality such that a description of one of those components with respect to one figure is applicable to other components with the same name in other drawings. Also, in the drawings and the following description, components shown and described in connection with some examples are capable of being used with or incorporated into other examples. In some examples, a component illustrated in a certain drawing is not limited to use in connection with the example to which the drawing pertains, but is usable with or incorporated into other examples, including examples shown in other drawings.

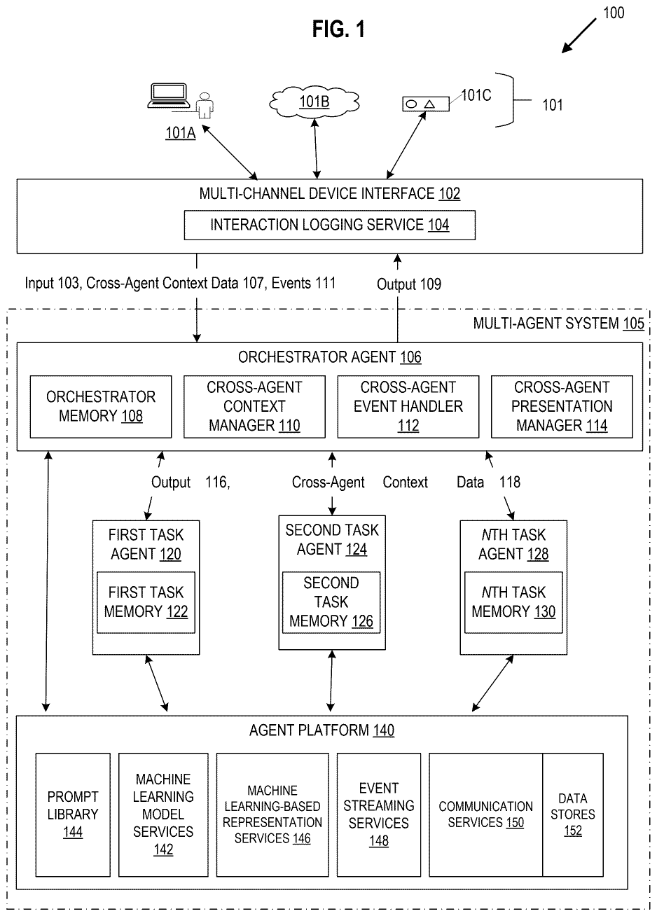

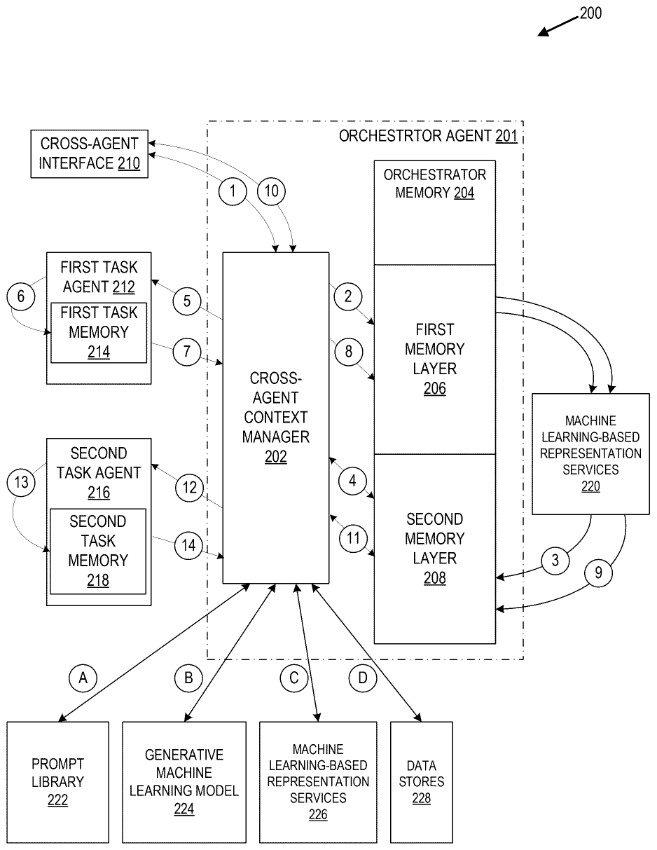

FIG. 1 is a component-based flow diagram of an example method for multi-agent management in a multi-agent system in accordance with some examples of the present disclosure.

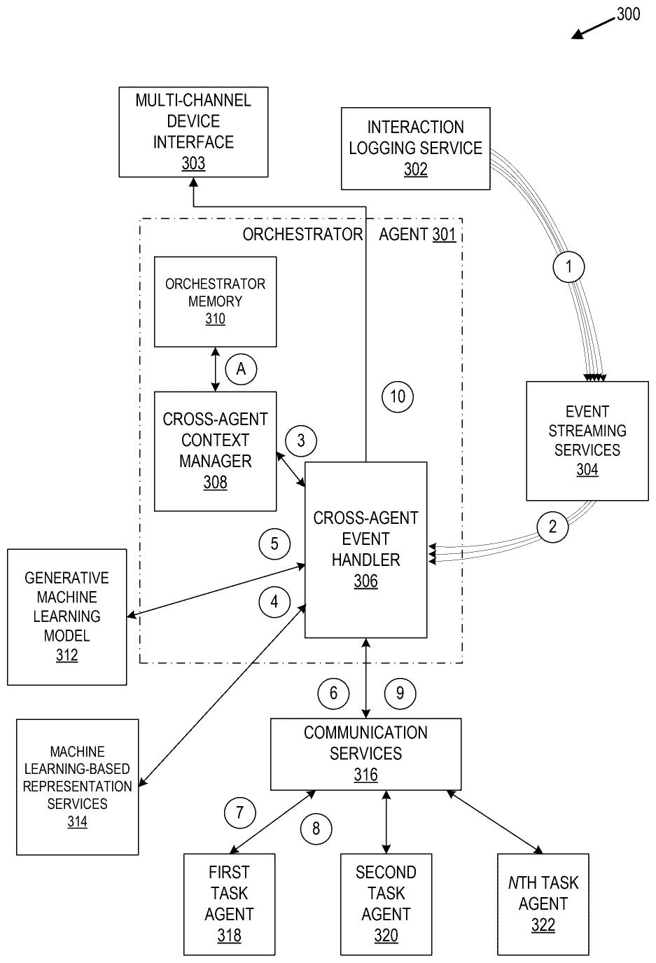

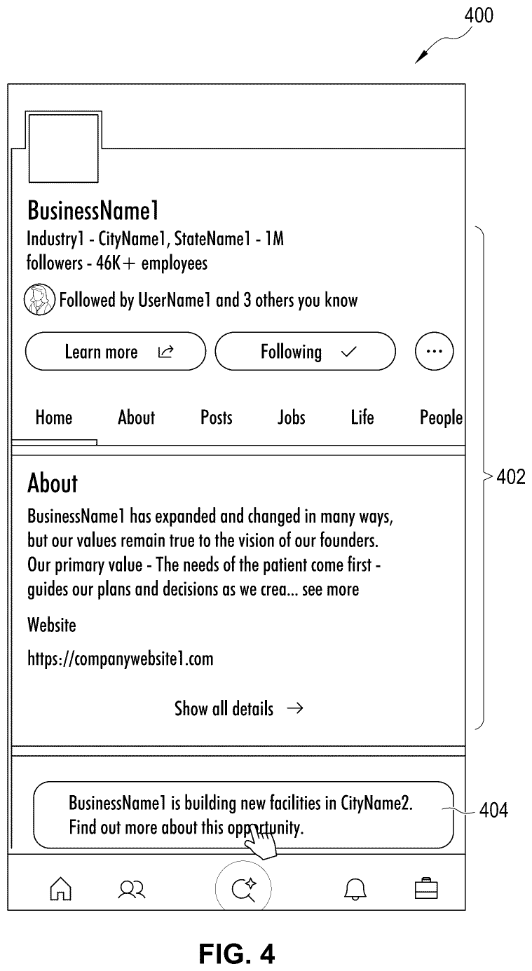

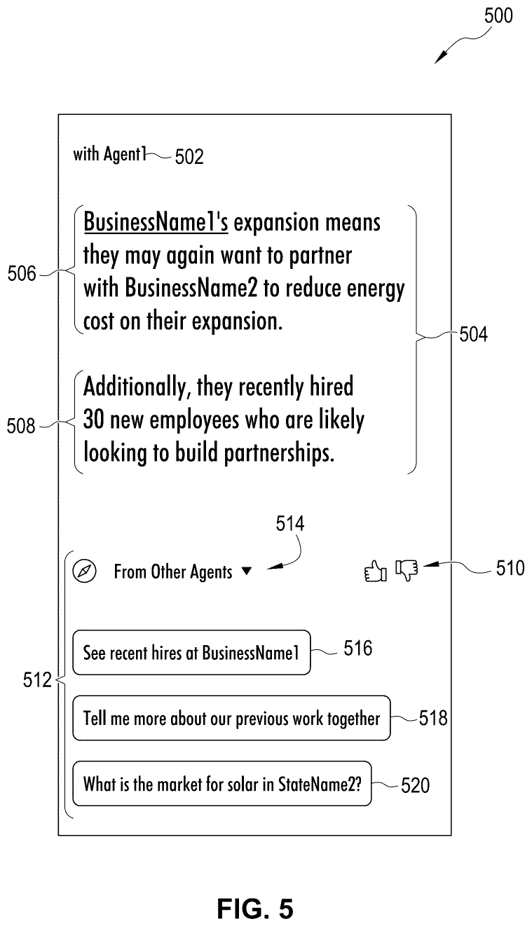

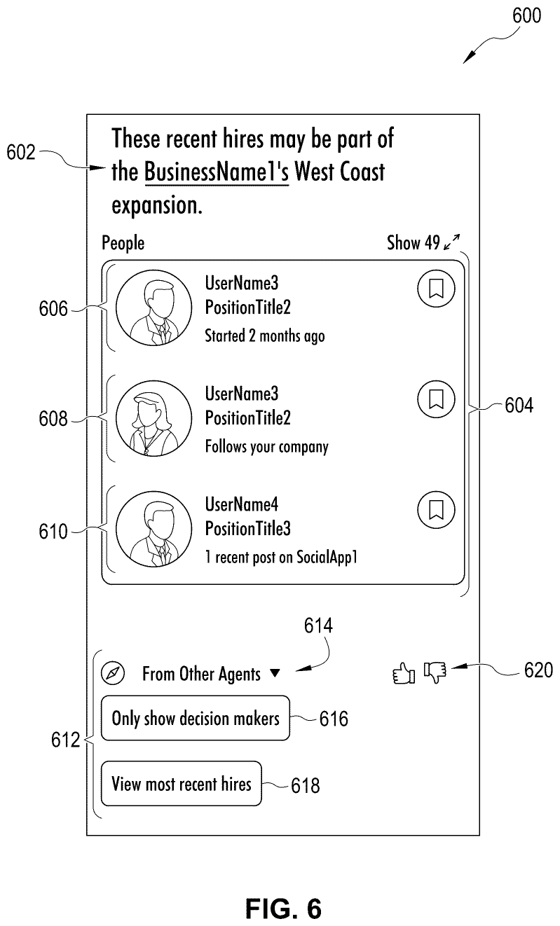

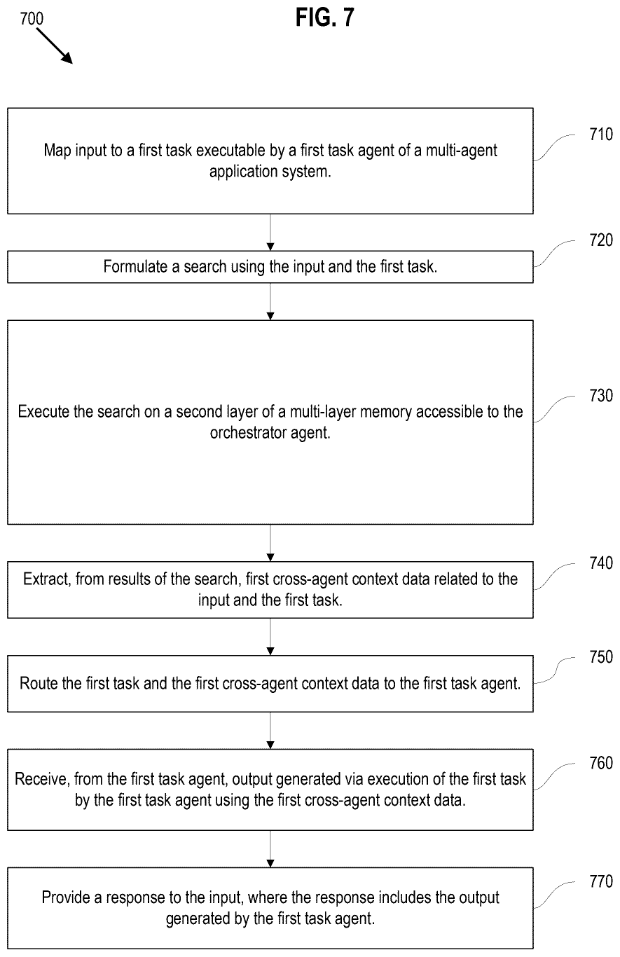

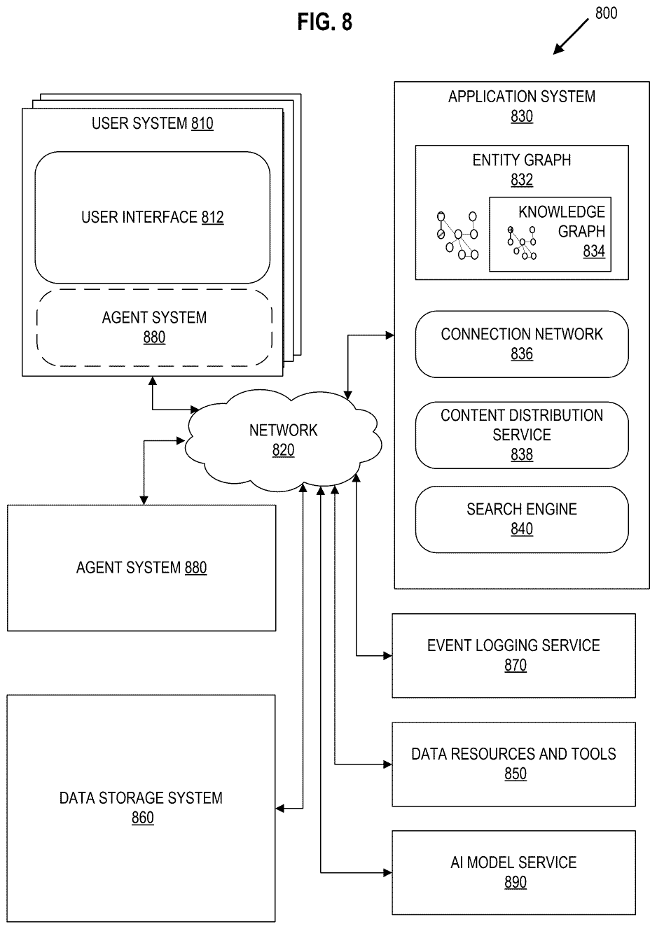

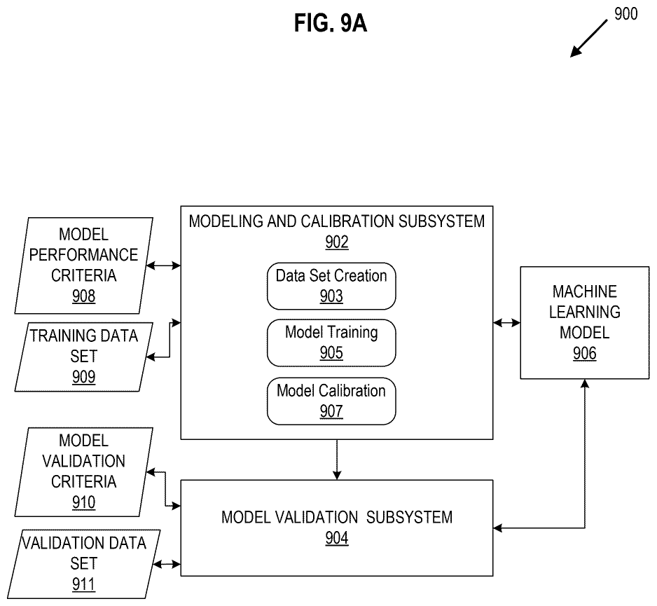

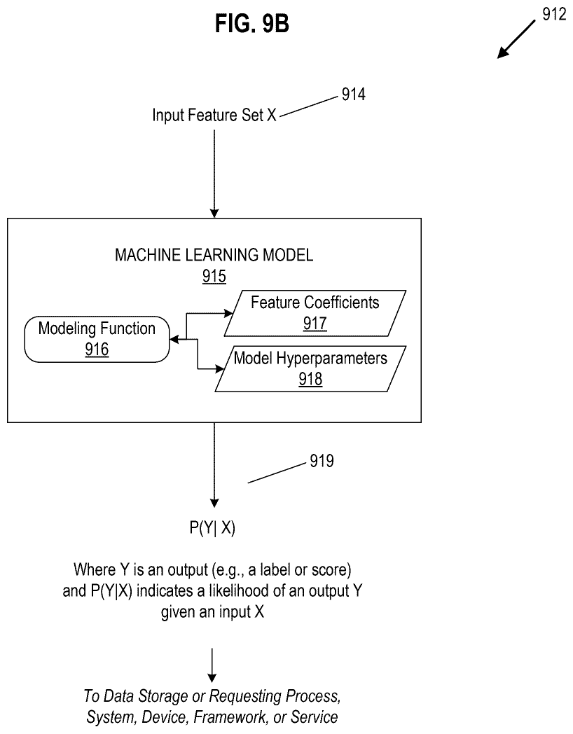

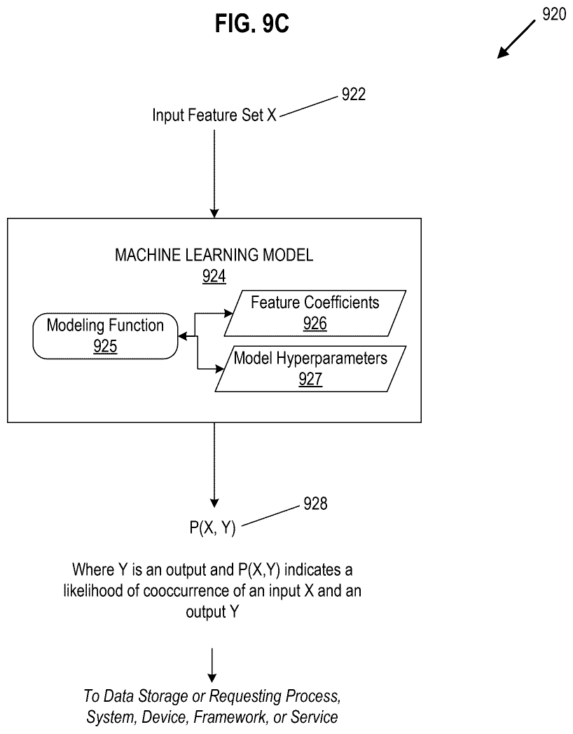

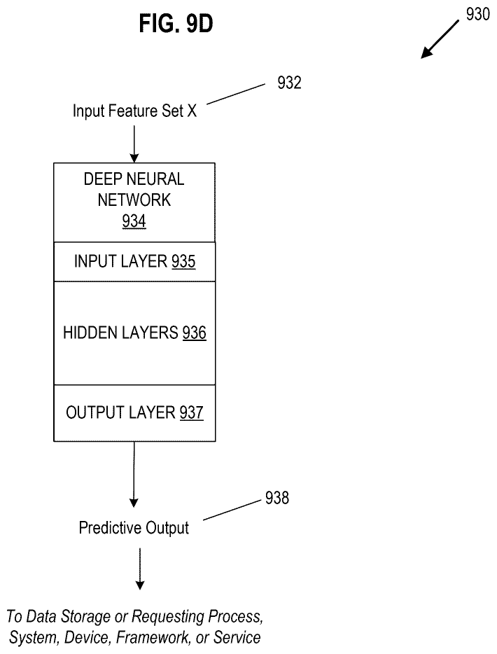

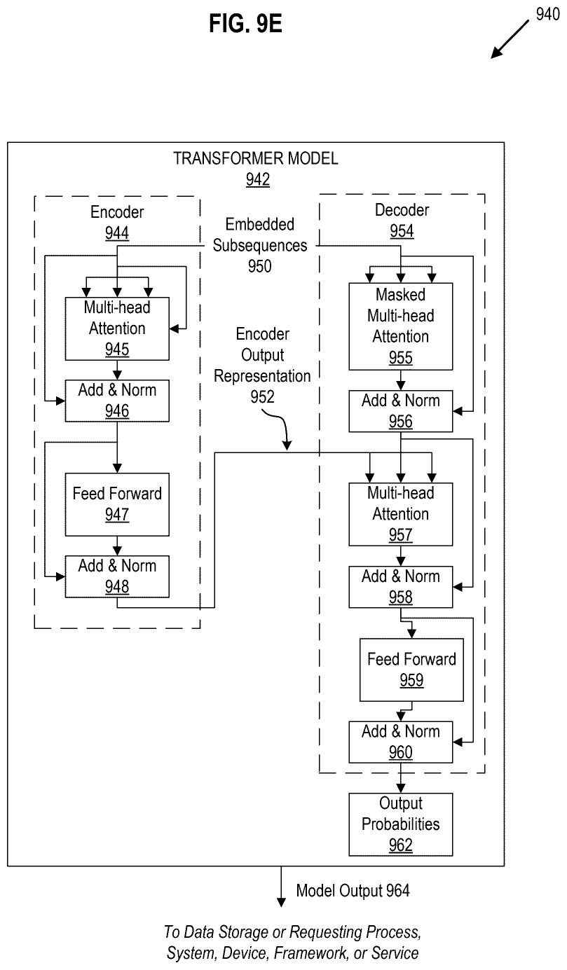

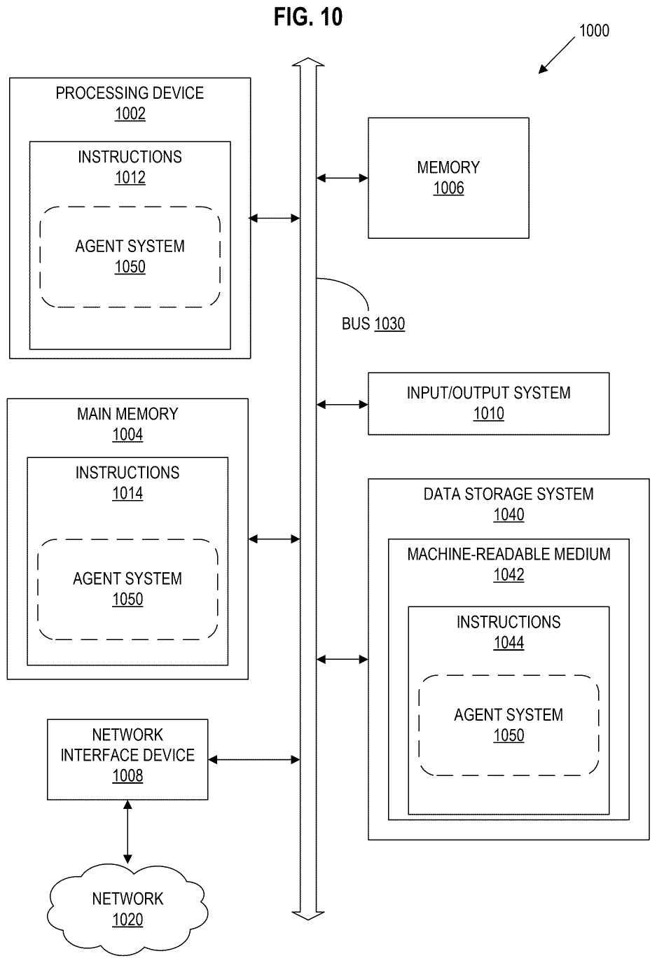

The method 100 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 100 is performed by the computing system components shown in FIG. 1. In other examples, portions of the method are performed by one or more of the computing system components shown in FIG. 2, FIG. 3, FIG. 4, FIG. 5, FIG. 6, FIG. 7, one or more components of computing system 800 of FIG. 8, one or more machine learning models of FIG. 9A, FIG. 9B, FIG. 9C, FIG. 9D, or FIG. 9E, and/or one or more components of computing system 1000 of FIG. 10. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

In FIG. 1, the method 100 is represented by arrows connecting components of a computing system. The computing system includes an environment 101, a multi-channel device interface 102, and a multi-agent system 105.

The environment 101 includes one or more user devices 101A, a network 101B, and/or one or more sensing devices 101C. Examples of user devices 101A include computing devices, such as laptop computers, smart phones, mobile computing devices, smart appliances, wearable devices, game controls, vehicle controls, buttons, switches, robotic devices, etc. Examples of networks 101B include wireless, optical, and/or wired communication networks. A non-exhaustive list of examples of sensing devices 101C includes motion sensors, load cells, force sensors, light sensors, temperature sensors, physiological sensors, energy sensors, and network sensors.

The multi-channel device interface 102 includes an application layer, presentation layer, and/or data layer of one or more software applications. In some examples, the multi-channel device interface 102 manages and facilitates electronic and/or electromagnetic communications between components of the environment 101 and the multi-agent system 105 across a single channel, such as unified, cross-agent user interface managed by the orchestrator agent 106. Alternatively or in addition, the multi-channel device interface 102 manages and facilitates communications between components of the environment 101 and one or more other channels, such as other user interfaces not associated with the multi-agent system 105. An example of a cross-agent interface managed by the orchestrator agent 106 is a common user interface that serves as an entry point to multiple different functionalities of the multi-agent system 105. An example of an interface not directly associated with the multi-agent system 105 is a user interface that serves as an entry point to a software application or a portion of a software application that is not part of the multi-agent system 105.

The multi-channel device interface 102 includes an interaction logging service 104. Responsive to receiving signals from one or more components of the environment 101, the interaction logging service 104 stores the received signals in memory for subsequent access and processing by the orchestrator agent 106. Via the orchestrator agent 106, the multi-channel device interface 102 provides portions of output 116 produced by components of the multi-agent system to one or more components of the environment 101. The output 109 includes digital data such as textual or multimodal content, control signals, messages, etc. In some examples, the output 109 provided by the multi-channel device interface 102 to the environment 101 includes digital content (e.g., search results, recommendations, notifications, user interface elements) capable of being presented to the user via a graphical or multimodal user interface at one or more user devices 101A. In other examples, the output 109 provided by the multi-channel device interface 102 to the environment 101 includes control signals and/or data signals capable of being transmitted to another device, network, system, or application.

The multi-agent system 105 includes an orchestrator agent 106, an agent platform 140, and task agents including a first task agent 120, a second task agent 124, and an Nth task agent 128, where the total number of task agents N is a positive integer greater than or equal to two.

In some examples, the multi-agent system 105 includes a multi-application online platform in which the orchestrator agent 106 selectively maps inputs 103 to task agents and each task agent 120, 124, 128 performs a different vertical application or functionality, including pull-based search, push-based recommendation, and asynchronous messaging functionalities. In some examples, the multi-agent system 105 includes one or more task agents 120 that perform different types of user account monitoring to detect and remove anomalous login accounts from the online platform. In some examples, the multi-agent system 105 corresponds to a multi-function device or system, such as a smart appliance, a vehicle or a robot, and the task agents 120, 124, 128 each perform a different function of the multi-function device or system.

In the multi-agent system 105, the orchestrator agent 106 is in bidirectional communication with the multi-channel device interface 102 and the task agents 120, 124, 128. The orchestrator agent 106 manages and coordinates the operations of the task agents 120, 124, 128. In some examples, the orchestrator agent 106 receives input 103 from a component of the environment 101 via multi-channel device interface 102, determines a task that corresponds to the input 103, assigns the task to a task agent 120, 124, 128, receives output 116 from the task agent assigned to the task, formulates the output 116 from the task agent into a response (e.g., output 109), and provides the response to the component of the environment 101 via multi-channel device interface 102. In some examples, the orchestrator agent 106 passes the output 116 of one task agent to another task agent to perform another task asynchronously, and then provides output 109 to the environment 101 based on the output 116 of the asynchronous task.

In various examples, the orchestrator agent 106 uses various tools to classify inputs, map inputs to task agents, and obtain portions of cross-agent context data 107, 118 to selectively share with task agents, such as prompt libraries, machine learning models, machine learning-based representation services, event streaming services, communication services, and data stores. These tools are accessible to the orchestrator agent 106 via agent platform 140, described below. For instance, the tools are accessible to the orchestrator agent 106 via queries, prompts, function calls, remote procedure calls, application programming interfaces (APIs), inter-process communications, and/or other mechanisms.

In some examples, the tasks performed by the task agents 120, 124, 128 are at a lower level of abstraction than the tasks performed by the orchestrator agent 106. In some examples, the orchestrator agent 106 performs higher-level or first-level intent classification tasks that manage cross-agent context data 107, 118 and map inputs 103 received from the environment 101 via multi-channel device interface 102 to one or more task agents, while individual task agents 120, 124, 128 each perform second-level intent classification on the information received for the orchestrator agent 106 and perform respective tasks at a lower level of abstraction.

In some examples, the orchestrator agent 106 operates at a domain-independent level of abstraction while each task agent operates at a domain-specific level of abstraction. For instance, if orchestrator agent 106 classifies an input 103 as indicating an intent to search for jobs, the orchestrator agent 106 maps the input 103 to a task agent that is capable of executing job searches, i.e., to the high-level intent category of job search. The job search task agent then performs a second-level intent classification in which it determines the specific type of job search and parameters it needs to execute the particular job search requested by the input 103.

The orchestrator agent 106 is capable of invoking task agents in multiple different ways depending upon the cross-agent context data. The orchestrator agent 106 invokes task agents synchronously in response to explicit data, e.g., inputs 103 from the environment 101. Alternatively or in addition, orchestrator agent 106 invokes task agents asynchronously in response to explicit data, e.g., inputs 103 from the environment. A synchronous task triggers one or more asynchronous tasks, in some examples. Still alternatively or in addition, orchestrator agent 106 invokes task agents proactively and in response to implicit data, e.g., a mapping of cross agent context data 107, 116 to events 111. Orchestrator agent 106 invokes tasks synchronously when the tasks are capable of being performed with low latency to respond to inputs 103 from the environment 101 in a real time manner, e.g., using a question and answer paradigm. Orchestrator agent 106 invokes tasks asynchronously for more complex or resource intensive tasks that often have higher latency. Orchestrator agent 106 invokes tasks proactively to improve the performance of the multi-agent system 105 and its responsiveness to the current system state as evidenced by cross-agent context data 107, 118.

In various examples, the task agents 120, 124, 128 use various tools to execute respective tasks, such as prompt libraries, machine learning models, machine learning-based representation services, event streaming services, communication services, and data stores. These tools are accessible to the task agents 120, 124, 128 via agent platform 140, described below. For instance, the tools are accessible to the task agents 120, 124, 128 via queries, prompts, function calls, remote procedure calls, application programming interfaces (APIs), inter-process communications, and/or other mechanisms.

In the above example, the orchestrator agent 106 stores communications between the orchestrator agent 106 and the multi-channel device interface 102, and stores communications between the orchestrator agent 106 and the task agent assigned to a task (e.g., a job search agent), in memory that is accessible to the orchestrator agent 106. These communications involving the orchestrator agent 106 often include cross-agent context data 107, 118; e.g., information that is potentially usable by more than one of the task agents 120, 124, 128 to perform other tasks.

The orchestrator agent 106 uses cross-agent context data 107, 118 to determine the current state of the multi-agent system 105. Examples of cross-agent context data 107, 118 include intent classifications or categories, interaction histories, event logs, performance metrics, evaluation results, entity preferences, and entity metadata, which is accessible to the orchestrator agent 106 via communications between the orchestrator agent 106 and multi-channel device interface 102 and/or task agents 120, 124, 128. In some examples, cross-agent context data 107, 118 includes graph data that represents relationships between entities, such as graph data extracted from an entity graph or knowledge graph, described with reference to FIG. 8.

The orchestrator agent 106 includes an orchestrator memory 108. Each task agent 120, 124, 128 includes a respective task memory, e.g., first task memory 122, second task memory 126, Nth task memory 130. In managing and coordinating communications with the multi-channel device interface 102 and the task agents 120, 124, 128, the orchestrator agent 106 collects cross-agent context data 107, 118 and stores the cross-agent context data 107, 118 in the orchestrator memory 108, while the task agents each collect respective task-specific data and store their respective task-specific data in their respective task memories 122, 126 130. In some examples, the orchestrator memory 108 includes multiple different memory layers, where each layer of the memory stores a different version, or a different representation, or a different type of representation, of cross-agent context data 107, 118.

Access to the orchestrator memory 108 is restricted to the orchestrator agent 106, such that data stored in the orchestrator memory 108 is not directly accessible to the task agents 120, 124, 128 except via the orchestrator agent 106, in some examples. In some examples, access to the task memories 122, 126, 130, is restricted to the respective task agents 120, 124, 128, such that data stored in a task memory 122, 126, 130 of a respective task agent 120, 124, 128 is not directly accessible to other task agents or to the orchestrator agent 106. Examples of orchestrator memory 108 are described in more detail with reference to FIG. 2.

The orchestrator agent 106 includes a cross-agent context manager 110. Cross-agent context manager 110 manages the collection of cross-agent context data 107, 118 by the orchestrator agent 106, manages the storing of collected cross-agent context data 107, 118 in the orchestrator memory 108, and manages the selective sharing of cross-agent context data 107, 118 stored in the orchestrator memory 108 with task agents 120, 124, 128. In some examples, the cross-agent context manager 110 is responsive to requests or queries from the orchestrator agent 106.

In some examples, when the orchestrator agent 106 classifies an input 103 received from the environment via the multi-channel device interface 102 into an intent category, the orchestrator agent 106 invokes the cross-agent context manager 110 to retrieve cross-agent context data 107, 118 related to the input 103 and/or the intent category, the cross-agent context manager 110 queries the orchestrator memory 108 to retrieve the related cross-agent context data 107, 118, and the orchestrator agent 106 uses the retrieved cross-agent context data 107, 118 to classify the input 103 into associated intent category. In some examples, the orchestrator agent 106 directly maps the input 103 to one or more task agents. In other examples, the orchestrator agent 106 first maps the input 103 to an intent category and then maps the intent category to one or more task agents. The cross-agent context manager 110 is capable of selectively providing related cross-agent context data 107, 118, to either or both of these steps.

Once the orchestrator agent 106 has mapped an input 103 to a task agent, the cross-agent context manager 110 selectively provides cross-agent context data 107, 118 to the identified task agent that has been mapped to the input 103 (either directly mapped or via an intent category). The cross-agent context data 107, 118 provided to the identified task agent is the same as or different from the cross-agent context data 107, 118 used to identify the task agent, and/or the cross-agent context data 107, 118 used to map the input 103 to an intent category is the same as or different from the cross-agent context data 107, 118 provided to the identified task agent, and/or the cross-agent context data 107, 118 used to identify the task agent. That is, the cross-agent context manager 110 is capable of determining different portions of cross-agent context data 107, 118 for different tasks or processes performed by other components of the orchestrator agent 106 or task agents 120, 124, 128.

In various examples, the cross-agent context manager 110 uses various tools to collect and manage cross-agent context data 107, 118, and selectively identify portions of cross-agent context data 107, 118 to share with the orchestrator agent 106 and task agents 120, 124, 128, such as prompt libraries, machine learning models, machine learning-based representation services (e.g., semantic search, retrieval augmented generation (RAG), event streaming services 148, communication services 150, and data stores 152. These tools are accessible to the cross-agent context manager 110 via agent platform 140, described below. For instance, the tools are accessible to the cross-agent context manager 110 via queries, prompts, function calls, procedure calls, application programming interfaces (APIs), inter-process communications, and/or other mechanisms.

In the example of FIG. 1, the orchestrator agent 106 periodically receives events 111 from one or more components of the environment 101 via the interaction logging service 104 of the multi-channel interface 102. To process events 111, orchestrator agent 106 includes a cross-agent event handler 112. Cross-agent event handler 112 filters events 111 according to filtering criteria and selectively routes subsets of the filtered events 111 to task agents 120, 124, 128. The events 111 that are selectively routed to task agents 120, 124, 128 are processed by task agents 120, 124, 128, in a similar manner as input 103.

In some examples, a task agent is capable of generating output 116 and/or initiating an asynchronous process in response to an event 111, an input 103, or a combination of an event 111 and an input 103. The ability to generate asynchronous communications enables different task agents to handle different tasks asynchronously. This capability enables output 116 generated by different task agents to be presented to the user at different times, proactively, and also independently of the user's current interaction state with respect to the multi-agent system. For instance, asynchronous task execution enables the orchestrator agent to present a notification generated by a first task agent to the user while a second task agent is performing a different and perhaps unrelated task.

In some examples, cross-agent event handler 112 proactively routes an event 111 (e.g., a user clicking on a recommendation, a fraud monitor identifying an anomalous user account, a control system detecting a signal, etc.) associated with a first task performed by first task agent 120 to second task agent 124, based on a determination that the event 111 is related to a task that the second task agent 124 has performed or is capable of performing. In some examples, various task agents 120, 124, 128 subscribe to various event types and the cross-agent event handler 112 proactively routes events 111 to task agents according to the event types for which the respective task agents have subscribed.

In some examples, cross-agent event handler 112 invokes cross-agent context manager 110 to obtain cross-agent context data 107, 118 related to events 111 from orchestrator memory 108, and selectively routes combinations of events 111 and related cross-agent context data 107, 118 to task agents 120, 124, 128 in a proactive manner.

In various examples, the cross-agent event handler 112 uses various tools to filter and route events 111 to task agents 120, 124, 128, such as prompt libraries, machine learning models, machine learning-based representation services, event streaming services, communication services, and/or data stores. These tools are accessible to the cross-agent event handler 112 via agent platform 140, described below. For instance, the tools are accessible to the cross-agent event handler 112 via queries, prompts, function calls, procedure calls, application programming interfaces (APIs), inter-process communications, and/or other mechanisms.

The orchestrator agent 106 includes a cross-agent presentation manager 114. Cross-agent presentation manager 114 formulates output 109 for presentation to one or more components of the environment 101 via multi-channel device interface 102, using, e.g., render templates, in accordance with applicable presentation standards, performance thresholds, and/or evaluation thresholds, the values of which are determined in accordance with requirements or design of a particular multi-agent system 105.

In some examples, such as where the multi-channel device interface 102 functions as a unified entry point for multiple different vertical applications, the cross-agent presentation manager 114 applies presentation standards (e.g., visual elements, aesthetics, tone, etc.) for the unified interface to task agent output 116 to convert the output 116 to the output 109 (e.g., a format that is consistent or common across all of the task agents 120, 124, 128). Thus, in some examples, the cross-agent presentation manager 114 ensures that task agent output 116 generated by any or all of the task agents 120, 124, 128 is presented as output 109 via a common, ubiquitous entry point, where the presentation standards applied by the cross-agent presentation manager 114 provide a consistent user experience despite the fact that different tasks may be performed asynchronously by different task agents.

In some examples, cross-agent presentation manager 114 formulates message histories, e.g., threads, of communications between the orchestrator agent 106 and the multi-channel device interface 102 using render templates, to enable the communication history between specific components of the environment 101 and the orchestrator agent 106 to be provided as output 109. In some examples, cross-agent presentation manager 114 provides a user's communication history with the orchestrator agent 106 to the multi-channel device interface 102 for presentation to the user via the environment 101.

In some examples, cross-agent presentation manager 114 applies performance thresholds (e.g., latency requirements) to task agents 120, 124, 128 such that output 116 of a task agent is excluded from the output 109, or a subset of the output 116 is included in the output 109, if the performance thresholds are not met or exceeded. In some examples, cross-agent presentation manager 114 applies evaluation thresholds (e.g., spam filters, filters for inappropriate content, validation criteria, etc.) to task agent output 116 to formulate the output 109 such that output 116 of a task agent is excluded from the output 109, or a subset of the output 116 is included in the output 109, if the evaluation thresholds are not met or exceeded.

In various examples, the cross-agent presentation manager 114 uses various tools to control and regulate the presentation of output 109 to components of the environment 101 via the multi-channel device interface 102, such as prompt libraries, machine learning models, machine learning-based representation services, event streaming services, communication services, and data stores. These tools are accessible to the cross-agent presentation manager 114 via agent platform 140, described below. For instance, the tools are accessible to the cross-agent presentation manager 114 via queries, prompts, function calls, procedure calls, application programming interfaces (APIs), inter-process communications, and/or other mechanisms.

The agent platform 140 includes a prompt library 144, machine learning model services 142, machine learning-based representation services 146, event streaming services 148, communication services 150, and data stores 152.

The prompt library 144 includes a searchable data store that stores generative machine learning model (GMLM) prompts or prompt templates, which are used by the orchestrator agent 106 and/or task agents 120, 124, 126 to communicate with one or more generative machine learning models. A GMLM prompt includes one or more GMLM instructions that are formulated to cause a GMLM to perform a specific task, sequence of tasks, or group of tasks. The instructions contained in a GMLM prompt are often formulated using natural language as opposed to computer programming code. A prompt template is a parameterized prompt, which contains one or more GMLM instructions and placeholders for input values.

Some GMLM prompts include few-shot examples in addition to instructions. A few-shot example often includes an input-output pair. The input-output pair provides guidance to the GMLM as to the type of output commonly associated with the corresponding type of input in the input-output pair. The GMLM uses the few-shot examples as context in performing a task described by an instruction. For instance, an intent classification prompt for the orchestrator agent 106 is likely to contain different few-shot examples than the intent classification prompts for the task agents. For instance, an intent classification prompt for the orchestrator agent 106 is likely to include examples of inputs paired with high-level intent categories that correspond to tasks performed by the task agents 120, 124, 128, while an intent classification prompt for a task agent 120, 124, 128 is more likely to include examples of inputs paired with domain-specific intents that correspond to sub-tasks performed by an individual task agent.

In some examples, the orchestrator agent 106 uses cross-agent context data 107, 118 to formulate few-shot examples for GMLM prompts. For instance, a few-shot example could include a pair of machine learning-based representations, such as a representation of cross-agent context data and a machine learning-based representation of a corresponding intent category or task. Examples of generative machine learning models and prompts are described with reference to FIG. 9A, FIG. 9C, FIG. 9D, and FIG. 9E.

In some examples, the prompt library 144 stores a prompt or prompt template that has been specifically formulated to cause a GMLM to generate and output a first-level intent classification for the orchestrator agent 106, e.g., an intent category, in response to an input and related cross-agent context data obtained by the cross-agent context manager 110. In some examples, the prompt library 144 contains a prompt or prompt template that has been formulated to cause a GMLM to generate and output a list of one or more task agents that match or correspond to a combination of input, intent classification, and/or related cross-agent context data, which the orchestrator agent 106 uses to select a task agent to perform a task in response to the input. In some examples, the prompt library 144 contains a prompt or prompt template that has been formulated to cause a GMLM to generate and output a list of one or more task agents that match or correspond to a combination of event data and related cross-agent context data, which the cross-agent event handler 112 or orchestrator agent 106 uses to select a task agent for routing of the event.

The machine learning model services 142 includes one or more machine learning models and related services, such as model training, validation, and serving platforms. The machine learning model services 142 include one or more generative machine learning models (GMLMs) and/or other types of machine learning models, such as discriminative models formulated for intent classification. Examples of machine learning models that are capable of being supported by machine learning model services 142 are described with reference to FIG. 9A, FIG. 9B, FIG. 9C, FIG. 9D, and FIG. 9E.

The machine learning-based representation services 146 include services that enable searching and matching using machine learning-based representations, such as vectors and embeddings. Machine learning-based representation services 146 include one or more representation models, e.g., embedding generators. Representation models receive variable length input and output a fixed length representation of the information contained in the variable length input, in accordance with the training data used to train the representation models.

The machine learning-based representation services 146 also include services that use machine learning-based representations to perform searching or matching tasks, such as embedding-based retrieval, semantic search, and/or retrieval augmented generation. These services are used by orchestrator agent 106 to selectively retrieve cross-agent context data from orchestrator memory 108, and/or to map inputs to intent categories or task agents, and/or to map intent categories to task agents, and/or to map events to task agents.

The event streaming services 148 enable the ingestion and processing of streaming data in real time. In some examples, the event streaming services 148 provide data stream processing, a publish and subscribe messaging system, and real-time data storage services that support the interaction logging service 104 and cross-agent event handler 112. In some examples, the event streaming services 138 facilitate the mapping of events 111 to task agents 120, 124, 128.

The communication services 150 provide pull-based, push-based, and asynchronous communications capabilities. In some examples, the communication services 150 enable synchronous, asynchronous, and proactive task execution and communications. Synchronous task execution and communications involve calling task agents to execute tasks in response to requests in the same thread as the request. Asynchronous task execution and communications involve invoking task agents asynchronously with respect to a synchronous task. For instance, a first task agent executing a first task synchronously invokes a second task agent that executes a second task asynchronously with respect to the first task. The asynchronous task execution is executed outside of the synchronous task thread such that the synchronous task can be completed without needing to wait for the asynchronous task to complete. Asynchronously executed tasks are often multi-step tasks or long running tasks in which a task agent first generates a plan, e.g., a directed acyclic graph (DAG) of sub-tasks and then executes the plan including the sub-tasks.

As used herein, proactive task execution and communication refers to a type of asynchronous task execution that occurs independently of or downstream of explicit user requests. One example of a proactive communication is a notification that updates the user as to the status of a task being executed by a task agent. Another example of a proactive task execution and communication is an acknowledgement of an explicit user request, where the acknowledgement is generated and presented to the user who initiated the request, and where the task is to be performed asynchronously, with the response to the request provided subsequent to the acknowledgement once the asynchronous execution has completed.

Another example of proactive task execution and communication is when the orchestrator agent establishes a listening mechanism that monitors an event stream for events of interest to a user or one or more task agents, where the events of interest are not explicit requests from the user. In the listening type of proactive task execution and communication, detection of an event of interest in the event stream initiates an asynchronous task execution and/or communication in which one or more task agents execute tasks in response to the event detection. In some examples, the orchestrator agent sends the event of interest to multiple different task agents, collects prospective notifications that the task agents have generated in response to the event, selects from among those prospective notifications those notifications that most closely match the event of interest and/or user preferences or user context, determines optimal timing, presentation channel, and format for the selected notifications, and initiates delivery of those notifications to the user with the optimal timing, presentation channel, and format.

In some examples, the described proactive task execution and communication functionalities are used to proactively provide multi-step or multi-task proactive recommendations involving task executions by multiple different task agents. In some examples, the described techniques are used to proactively generate a next job plan that involves using a first task agent to generate a draft resume, using a second task agent to generate suggested draft skills for the user to incorporate into the user's profile, a third task agent to generate suggested employers for the user to connect with, including suggested contacts at those prospective employers, and a fourth task agent to generate the next job plan, where the first, second, third, and fourth task agents are the same agent in some examples and different agents in other examples.

In some examples, the next job plan proactively generated by one or more task agents includes a series or group of steps or tasks suggested to the user to achieve a goal such as being promoted to a new job title, e.g., online learning recommendations to help position the user to become a senior staff engineer, where the online learning recommendations are mapped to specific skills the user is suggested to develop to achieve the goal. In some examples, the next job plan includes a list of available jobs and the associated employers, where the list of jobs is generated by one or more task agents using information stored in the orchestrator memory, where the information used to generate the jobs list includes context information extracted from communications between the user and the online platform, and/or information extracted from other sources such as a graph database or search engine optimization (SEO) tools (e.g., search histories on a search engine). One or more task agents proactively generate job plans and/or portions of job plans (e.g., recommendations) using various combinations of context information from these and/or other sources (e.g., information obtained from the user's direct interaction history with the platform and/or information from other sources external to the platform).

In some examples, a multi-step plan generated by one or more task agents using the techniques described, includes the proactive generation of additional subsequent tasks, such as proactively generating a first draft of a message for the user to send to connect with a prospective employer, and a corresponding notification providing the reasoning used by the multi-agent task system for generating the message, e.g., “I see that you're applying to CompanyA. Here's a draft message that your Jobs Agent has put together to the bead recruiter in machine learning engineering at CompanyA.” In this example, the multi-agent system prompts the user to review and modify or accept the draft message and indicate whether the message is approved to be sent. In these and other ways, the proactive listening-based task execution and communication capabilities of the described multi-agent system enable the task agents to automatically and proactively generate multiple different types of tasks and groups or sequences of tasks or multi-step tasks and communications using context data from a variety of different sources, without being explicitly prompted by the user.

The communication services 150 include asynchronous communication services such as an asynchronous messaging platform. In some examples, the communication services 150 support a large (e.g., millions or hundreds of millions) base of user accounts on a global online platform. The communication services 150 provide threaded memory that enables the orchestrator agent 106 to manage a variety of communications between the orchestrator agent 106 and the multi-channel device interface 102, the task agents 120, 124, 128, and the components of the agent platform 140, asynchronously, such that specific threads are enabled for specific task agents and/or other entities. The communication services 150 enable the orchestrator agent 106 to automatically synchronize communications between the orchestrator agent 106 and components of the environment 101, across different sessions and devices, via multi-channel device interface 102.

The data stores 152 are capable of storing information and content used by the various agents and components of the multi-agent system 105, such as cross-agent context data, machine learning-based representations, inputs, and outputs. In some examples, the data stores include vector databases that store machine learning-based representations and real-time or nearline data stores that store messages and message threads. For instance, a data store 152 could store pre-computed machine learning-based representations of intent categories or tasks.

As described in more detail below, components of the described multi-agent system 105 provide a number of functionalities that selectively leverage cross-agent context data to improve push-based communications as well as pull-based functions. The shared availability of the cross-agent context data enables increased use of proactive, asynchronous tasks and provides increased reliability in task and event routing processes performed by the orchestrator agent 106, especially when the input is ambiguous. Prompt-based task and event routing by the orchestrator agent 106 leverages the capabilities of a GMLM to select the most suitable agents for particular intents (e.g., the task agents with the highest probability of matching the intents) based upon the related cross-agent context data. This in turn increases the likelihood that the performance of the tasks will be responsive to the intents.

The examples shown in FIG. 1 and the accompanying description are provided for illustration purposes. This disclosure is not limited to the described examples.

FIG. 2 is a component-based flow diagram of an example method for cross-agent context management in a multi-agent system in accordance with some examples of the present disclosure.

The method 200 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 200 is performed by the computing system components shown in FIG. 2. In other examples, portions of the method are performed by one or more of the computing system components shown in FIG. 1, FIG. 3, FIG. 4, FIG. 5, FIG. 6, FIG. 7, one or more components of computing system 800 of FIG. 8, one or more machine learning models of FIG. 9A, FIG. 9B, FIG. 9C, FIG. 9D, or FIG. 9E, and/or one or more components of computing system 1000 of FIG. 10. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

In FIG. 2, the method 200 is represented by arrows connecting components of a computing system. The computing system includes a cross-agent context manager 202, an orchestrator memory 204, a cross-agent interface 210, a first task agent 212, a second task agent 216, machine learning-based representation services 220, prompt library 222, generative machine learning model (GMLM) 224, machine learning-based representation services 226, and data stores 228.

The descriptions of components shown in FIG. 1 having names similar to components shown in FIG. 2 are applicable to those corresponding components of FIG. 2, in some examples. Thus, cross-agent context manager 202 has similar functionalities as cross-agent context manager 110 of FIG. 1, in some examples. Cross-agent context manager 202 and orchestrator memory 204 are components of an orchestrator agent 201, in some examples. Orchestrator agent 201 is part of a multi-agent system and has similar functionalities as orchestrator agent 106 of FIG. 1, in some examples.

In the method 200, at (1), cross-agent context manager 202 receives, for an entity, first historical interaction data, from cross-agent interface 210. The first historical interaction data for the entity is logged over a time period such as a session or group of sessions by a logging service, e.g., interaction logging service 104. The first historical interaction data includes communications between the orchestrator agent 201 and the cross-agent interface 210, such as communications relating to tasks performed by task agents of the multi-agent system.

At (2), the cross-agent context manager 202 stores the first historical interaction data from cross-agent interface 210 in a first memory layer 206 of the orchestrator memory 204. The first memory layer 206 is a real-time or nearline data store for streaming data such as message threads. At (3), a representation modeling component of the machine learning-based representation services 220 creates machine learning-based representations of portions of the first historical interaction data and stores the corresponding machine learning-based representations in a second memory layer 208 of the orchestrator memory 204. The second memory layer 208 includes, e.g., a vector database. In some examples, the representation modeling component creates a machine learning-based representation for each separate interaction or group or series of related interactions in the historical interaction data so that the corresponding machine learning-based representation is a condensed or compressed representation of the information contained in the respective interaction, group, or series of related interactions.

At (4), cross-agent context manager 202 queries the second memory layer 208 using, e.g., semantic search, and obtains, from the second memory layer 208, first cross-agent context data related to a first input associated with the entity, where the first input is received via cross-agent interface 210. To perform (4), cross-agent context manager 202 communicates with a semantic search component of machine learning-based representation services 226 at (C).

At (5), the cross-agent context manager 202 uses the first cross-agent context data retrieved at (4) to map the first input to the first task agent 212, and passes the first input and the related first cross-agent context data to the first task agent 212. To perform (5), cross-agent context manager 202 communicates with prompt library 222 to formulate a GMLM prompt at (A). Cross-agent context manager 202 uses the formulated prompt to communicate with generative machine learning model 224 at (B) to identify the first task agent 212 as a task agent that has a highest probability of matching the input given the first cross-agent context data.

At (6), the first task agent 212 executes its respective task using the first input and the first cross-agent context data and stores task-specific data relating to the execution of the task in first task memory 214. At (7), the first task agent 212 communicates results of the execution of the task given the first input and the first cross-agent context data to cross-agent context manager 202. The communications between the first task agent 212 and the cross-agent context manager 202 at (7) are stored in first memory layer 206 of the orchestrator memory 204 at (8).

At (9) the representation modeling services of machine learning-based representation services 220 is invoked to create one or more machine learning-based representations of the communications between the first task agent 212 and the cross-agent context manager 202 stored in first memory layer 206 of the orchestrator memory 204 at (8), and these machine learning-based representations are stored in the second memory layer 208 at (9).

At (10), cross-agent context manager 202 receives a subsequent, second input from cross-agent interface 210. At (11), cross-agent context manager 202 retrieves second cross-agent context data from second memory layer 208 using the second input and, e.g., semantic search. The second cross-agent context data retrieved at (11) includes a subset of the cross-agent context data produced by the first task agent 212 and stored in the second memory layer 208 at (9).

At (12), the cross-agent context manager 202 uses the cross-agent context data produced by the first task agent 212 and stored in the second memory layer 208 at (9) to map the second input obtained at (10) to the second task agent 216. At (13), the second task agent 216 executes its respective task and stores task specific data in the second task memory 218.

At (14), the second task agent 216 communicates results of the execution of the task by the second task agent to cross-agent context manager 202. Subsequently, the communications between the second task agent 216 and the cross-agent context manager 202 at (14) are stored in first memory layer 206 of the orchestrator memory 204 and converted to machine learning-based representations that are stored in the second memory layer 208. Other communications between cross-agent context manager 202 and other task agents is processed in a similar manner using the first memory layer 206 and second memory layer 208 of the orchestrator memory 204.

The use of multiple memory layers to collect and manage cross-agent context data provides an efficient way to store the respective states of interactions between the orchestrator agent 201 and various task agents including the first task agent 212 and the second task agent 216, while also making portions of the cross-agent context data available to other task agents via the orchestrator agent 201. In some examples, each task agent controls the amount of data that it provides with the orchestrator agent 201 for cross-agent sharing, in accordance with, e.g., security policies applicable to the respective agent.

In an example, the processes described with reference to FIG. 2 to fetch relevant context for a search. For instance, a first task agent creates context data relating to a user's interactions with a news feed, such as the user's current interests, and provides that context data to the orchestrator agent. The context data from the first task agent is thereby accessible to a second task agent for use in formulating recommendations. In some examples, the shared context data accessible via the orchestrator agent is used to improve cold start situations, e.g., when a particular task agent is engaged for the first time for a particular user.

In another example, cross-agent context data created and shared with the orchestrator agent by a first task agent is used to initiate an asynchronous task to be performed either by the same agent or another agent. For instance, a first task agent executes a first task of posting a job listing online for a user and shares the information about the posted job with the orchestrator agent. The orchestrator agent invokes a second task agent to automatically start a search for candidates for the job based on the information shared by the first task agent, which is stored in the shared orchestrator memory.

The examples shown in FIG. 2 and the accompanying description are provided for illustration purposes. This disclosure is not limited to the described examples.

FIG. 3 is a component-based flow diagram of an example method for cross-agent event management in a multi-agent system in accordance with some examples of the present disclosure.

The method 300 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 300 is performed by the computing system components shown in FIG. 3. In other examples, portions of the method are performed by one or more of the computing system components shown in FIG. 1, FIG. 2, FIG. 4, FIG. 5, FIG. 6, FIG. 7, one or more components of computing system 800 of FIG. 8, one or more machine learning models of FIG. 9A, FIG. 9B, FIG. 9C, FIG. 9D, or FIG. 9E, and/or one or more components of computing system 1000 of FIG. 10. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

In FIG. 3, the method 300 is represented by arrows connecting components of a computing system. The computing system includes an interaction logging service 302, a multi-channel device interface 303, event streaming services 304, a cross-agent event handler 306, a cross-agent context manager 308, an orchestrator memory 310, a generative machine learning model (GMLM) 312, machine learning-based representation services 314, communication services 316, and task agents 318, 320, 322.

The descriptions of components shown in FIG. 1 having names similar to components shown in FIG. 3 are applicable to those corresponding components of FIG. 3, in some examples. Thus, cross-agent event handler 306 has similar functionalities as cross-agent event handler 112 of FIG. 1, in some examples. Cross-agent event handler 306 is a component of an orchestrator agent 301, in some examples. Orchestrator agent 301 is part of a multi-agent system and has similar functionalities as orchestrator agent 106 of FIG. 1, in some examples.

In the method 300, the cross-agent event handler 306 provides proactive task execution and communication functionalities including proactive listening and event-driven asynchronous task execution and communications. The cross-agent event handler 306 coordinates with the cross-agent context manager 308 to periodically obtain cross-agent context data from orchestrator memory 310, indicating the current state of the multi-agent system, determine the types of events to listen for via event streaming services 304, and, in response to detecting a listened—for event, determine what action to perform in response to the event, including identifying one or more task agents to process the event. Listening refers to a process of proactively monitoring a data stream for events that correspond to an event of interest using, for example, a publish and subscribe protocol. Whether an event in a data stream corresponds to an event of interest is determined by various approaches including comparing event metadata to the event of interest, in some examples.

The cross-agent event handler 306 is initialized with a pre-configured set of proactively listened-to events of interest and associated task agents. Any given task agent is capable of subscribing to zero or more events of interest via the orchestrator agent 301. Over time, as interactions with the multi-agent system are logged and processed, the cross-agent context data is updated and the cross-agent event handler 306 revises and updates the set of listened-to events of interest and/or the subscriptions of task agents to events.

For instance, if at a first time interval the cross-agent context data indicates that a user is interested in a particular topic with respect to a particular task, the cross-agent event handler 306 adds the topic to the list of events of interest for the task agent performing that task. If at a second time interval subsequent to the first time interval, the cross-agent context data indicates that the user is no longer interested in that topic with respect to the task, the cross-agent event handler 306 automatically removes the topic from the list of events of interest for the associated task agent.

The cross-agent context data used by the cross-agent event handler 306 to make event listening decisions and proactively route events to task agents includes signals received from other task agents and/or other users of the multi-agent system, in some examples. For instance, suppose a first task agent posts a job to an online platform for a first user. The orchestrator agent 301 could proactively initiate an asynchronous process to execute a search for potential hiring candidates that match the job description provided by the first user and notify the first user of the top candidates identified by the search immediately and/or at a later time.

Subsequently to the posting of the job by the first task agent, a second task agent executes a job search for a second user of the multi-agent system. Via the orchestrator agent 301, the cross-agent context data is updated in the orchestrator memory 310 to reflect the event of the second user's job search. The cross-agent event handler 306 proactively maps the occurrence of this event to the first task agent because the second user's job search contains search terms that correspond to portions of the first user's job description, for example. Thus, the cross-agent event handler 306 proactively routes the second user's job search event with the associated cross-agent context data to the first task agent. In response to the second user's job search event, the first task agent automatically and proactively generates a notification to the first user that the second user is a potential candidate for the job posted by the first user. An interaction of the second user with the first user's job post could similarly trigger a proactive notification event by the first task agent. In these examples, the cross-agent event handler 306 proactively enables connections between the first and second user that otherwise might not be established.

In another instance, a first task agent executes a job search for a first user at a first time interval. Subsequent to the first time interval, a second task agent posts an online job description on behalf of a second user. Via the cross-agent context manager 308 and orchestrator memory 310, the job posting event performed by the second task agent and associated context data is proactively routed by the cross-agent event handler 306 to the first task agent. The first task agent automatically and proactively generates and outputs a notification to the first user that the second user's job posting might be of interest to the first user.

In the method 300, at (1), event streaming services 304 receives interaction events from interaction logging service 302. The interaction events include various different types of interactions of various different components of an environment (e.g., environment 101) with the multi-agent system via an interface (e.g., multi-channel device interface 102) relating to tasks performed by various task agents of the multi-agent system.

At (2), event streaming services 304 provides a subset of these interaction events to cross-agent event handler 306. The event streaming services 304 applies subscriber-level filters and other types of filters (e.g., rules) to determine which interactions to include in and exclude from the subset of interaction events provided to cross-agent event handler 306. For instance, the event streaming services 304 includes only those events that are currently subscribed to by one or more task agents in the subset and excludes events that are not currently subscribed to by any of the task agents from the subset.

Using information and tools provided at (3), (4), and (5), cross-agent event handler 306 evaluates the events in the subset of interaction events received from event streaming services 304. At (3), to evaluate an event for a given entity (e.g., a user interacting with the multi-agent system), cross-agent event handler 306 invokes cross-agent context manager 308. Cross-agent context manager 308 obtains cross-agent context data related to the entity and the event by querying orchestrator memory 310 using, e.g., semantic search, and provides the cross-agent context data related to the entity and the event to the cross-agent event handler 306. In some examples, the cross-agent context data provided to the cross-agent event handler 306 is in the form of one or more machine learning-based representations. In some examples, the combination of the event and the cross-agent context data are mapped to an intent classification or intent category, and the intent classification or category is used to map the event to one or more task agents.

At (4), in some examples, cross-agent event handler 306 provides the event or intent to a representation model of machine learning-based representation services 314, and the representation model returns a machine learning-based representation of the event or intent to cross-agent event handler 306. At (5), the cross-agent event handler 306 provides the cross-agent context data obtained via (3) and the event obtained via (2) to a generative machine learning model 312 with a GMLM prompt that instructs the GMLM to evaluate and rank the task agents 318, 320, 322 using the event and the cross-agent context data. The GMLM prompt instructs the GMLM to select a subset of the task agents 318, 320, 322 with the highest probability of matching the event and context data. In response to the prompt, the GMLM provides a selected subset of the task agents 318, 320, 322 to the cross-agent event handler 306.

At (6) and (7), the cross-agent event handler 306 uses the GMLM output obtained via (4) to proactively route the event and associated cross-agent context data to one or more task agents of the subset of the task agents 318, 320, 322, e.g., the first task agent, via communication services 316. This proactive routing of events to task agents occurs asynchronously with other tasks being performed by the task agents. For instance, proactive routing of the event to the first task agent 318 occurs while or irrespective of a synchronous task being performed by the first task agent for the entity. Also, the cross-agent event handler 306 is able to proactively route events to task agents irrespective of whether the events involve the same task agent or different task agents. For instance, an event involving the first task agent is proactively routable to the first task agent or another agent, and an event involving another agent is proactively routable to the first task agent.

At (8) and (9), the first task agent 318 returns a response to the event received at (7) to the cross-agent event handler 306. In some examples, at (6) and (7), the cross-agent event handler 306 proactively broadcasts the event to multiple different task agents, such that at (8) and (9), those multiple different task agents each return a response to the event to the cross-agent event handler 306, using communication services 316.

A response to an event produced by a task agent includes digital content, such as a notification or proactive recommendation, in some examples. In other examples, a response to an event produced by a task agent includes a signal, such as a control signal or a trigger to initiate another task, such as an asynchronous task, to be performed by the same task agent or a different task agent.

At (10), the cross-agent event handler 306 evaluates the one or more responses to the event, which have been received from the task agents via communication services 316. In some examples, cross-agent event handler 306 invokes machine learning-based representation services 314 and/or GMLM 312 using a prompt configured to cause the GMLM 312 to execute a process of automatically sorting or ranking the responses and determining the most suitable response (e.g., the response that is the closest match to the event and cross-agent context data) to proactively provide to multi-channel device interface 303 for presentation to the entity via the environment (e.g., environment 101).

In the event routing processes described with reference to FIG. 3, the availability of cross-agent context data to the cross-agent event handler 306 and use of a GMLM prompt tuned to cause a GMLM to perform event-to-task agent mapping using the cross-agent context data is capable of improving the accuracy and reliability of tasks performed proactively by the task agents in response to events.

The examples shown in FIG. 3 and the accompanying description are provided for illustration purposes. This disclosure is not limited to the described examples.

FIG. 4, FIG. 5, and FIG. 6 are screen captures of example user interface displays in accordance with some examples of the present disclosure.

FIG. 4, FIG. 5, and FIG. 6 illustrate examples of processes described herein, including example depictions of graphical user interface elements, in accordance with some examples of the present disclosure. The user interfaces shown in FIG. 4, FIG. 5, and FIG. 6 are presented by an agent system, in some examples.

In the user interface examples shown in FIG. 4, FIG. 5, and FIG. 6, certain data that would normally be displayed via the user interface is anonymized for the purpose of this disclosure. In a live example, the actual data and not the anonymized version of the data would be displayed. For instance, the text “CompanyName” would be replaced with a name of an actual company and “FirstName LastName” would be replaced with a user's actual name.

The user interface elements shown in FIG. 4, FIG. 5, and FIG. 6 are presented to a user via one or more devices, e.g., by an application system. In some examples, portions of the user interface elements are implemented as one or more web pages that are stored, e.g., at a user device, a server or in a cache of a user device, and then loaded into a display of a user device via the user device sending a page load request to the server or fetching data from the cache.

The graphical user interface control elements (e.g., fields, boxes, buttons, etc.) shown in the screen captures are implemented via software used to construct the user interface screens. While the screen captures illustrate examples of user interface components, e.g., visual displays, buttons, input boxes, etc., this disclosure is not limited to the illustrated examples, or to visual displays, or to graphical user interfaces.

In FIG. 4, a user interface 400 illustrates an example of a display screen that is capable of being presented to a user via, e.g., a user system. The user interface 400 presents an entity profile page 402 to a user of an online system. In an example, the entity profile page 402 is retrieved by a first task agent of a multi-agent system having capabilities described herein. The first task agent executes the search that retrieves the entity profile page 402 synchronously, e.g., in response to an input and in the same thread as the input.

Using the described technologies, the user's interaction activities of inputting search criteria and viewing the entity profile page 402 include communications with an orchestrator agent of the multi-agent system. Those communications between the user interface 400 and the orchestrator agent are logged and stored in a memory that is accessible to the orchestrator agent. The event of viewing the entity profile page 402 corresponds to a listened-to event type managed by the orchestrator agent.

The orchestrator agent maps the page view event to a second task agent of the multi-agent system (e.g., a task agent that has subscribed to entity profile page view events or that has been identified via GMLM-based prompt routing, as described). The orchestrator agent provides the context data associated with the page view event (e.g., the user's search terms, the length of viewing time, information extracted from the entity profile page 402), generated via execution of the search task by the first task agent, from the orchestrator memory to the second task agent, as cross-agent context data.

In the illustrated example, the second task agent includes the cross-agent context data, originally generated via execution of a task by the first task agent and received by the second task agent from the orchestrator agent, in a search of news items. The second task agent retrieves a news item related to the entity described by the entity profile page 402 viewed by the user, generates a prospective notification, and provides the prospective notification to the orchestrator agent. The orchestrator agent evaluates the prospective notification received from the second task agent according to applicable evaluation and/or performance thresholds. The orchestrator agent applies one or more presentation standards to the prospective notification to produce the notification 404 and provide the notification 404 to the user interface 400.

The example of FIG. 4 illustrates how information learned by one task agent of a multi-agent system is sharable with another agent of the multi-agent system to improve the proactive notifications generated by other agents. As illustrated by the example of FIG. 4, the described technologies reduce the burden of input on the user because the proactive notifications are presented in the absence of an explicit request from the user. In addition, the ability to share context data from one task agent to another securely and efficiently via the orchestrator agent improves the routing of events to task agents and thereby conserves computing resources.

In FIG. 5, a user interface 500 illustrates an example of a display screen that is capable of being presented to a user via, e.g., a user system. The user interface 500 illustrates additional examples of proactive communications generated by multiple different task agents in response to the combination of the entity profile page view event described with reference to FIG. 4 and a subsequent event of the same user of clicking on the notification 404.

The user interface 500 includes a first section 502 that contains communications generated by a first agent (e.g., Agent1, the same agent that generated the push notification 404), and a second section 514 that contains communications generated by other agents of the multi-agent system in response to continuous updates in the context data developed by the first agent and shared with the orchestrator agent.

The first section 502 contains a text block 504 that includes two different communications 506, 508 generated by Agent1. For instance, the communications 506, 508 are generated by Agent1 querying a news feed for related news, in response to the user clicking on the notification 404.

The second section 514 includes a multimodal block 512, which displays interactive notification buttons 516, 518, 520. Each of the notification buttons 516, 518, 520 is generated by a different task agent of the multi-agent system in response to continuous updates in the cross-agent context data. For instance, the user hovering over communication 508 triggers a third task agent (e.g., a recruiter assistant agent) to generate the notification button 516, or the user viewing the communication 506 triggers a fourth task agent (e.g., a connections graph search agent) to generate the notification button 518, or the user clicking a feedback button 510 triggers a fifth task agent (e.g., a general purpose search agent) to generate the notification button 520.

The example of FIG. 5 illustrates how cross-agent context data is capable of being continuously updated and shared across multiple different task agents, including task agents that each perform different tasks, via an orchestrator agent and associated shared memory. Also, the user interface 500 illustrates how, via the orchestrator agent, the presentation of multiple different communications generated by multiple different task agents is synchronized and standardized to provide a consistent and easy to follow user interface design.

In FIG. 6, a user interface 600 illustrates an example of a display screen that is capable of being presented to a user via, e.g., a user system. The user interface 600 illustrates a result page presented to the user by the orchestrator agent in response to the user indicating interest in the communication 508 and/or the communication 516, of FIG. 5. For instance, the user interface 600 is presented in response to the user selecting the notification button 516.

The user interface 600 includes a text summary 602 and a result list 604. The text summary 602 references information contained in the cross agent context data developed from previous interactions of the user with the orchestrator agent and interactions between various task agents and the orchestrator agent. For instance, the text summary 602 summarizes the most recent cross-agent context data into an explanation of the search query executed to obtain the result list 604. The result list includes search results 606, 608, 610 obtained by a task agent via execution of the query that is summarized by text summary 602.

The user interface 600 includes a proactive communication section 612. The proactive communication section 612 includes notification buttons generated by one or more other task agents in response to continuous updates to the cross-agent context data. For instance, a lack of user interaction with the result list 604 or a user selection of the negative feedback button 620 triggers a task agent to generate the notification button 616 and/or the notification button 618.

In the example of FIG. 6, a first task agent (e.g., a GMLM-based text summarization agent) generates the summary 602 by applying a GMLM to portions of the cross-agent context data, a second task agent (e.g., a people search agent) generates and executes a search query using the summary 602, and one or more third task agents generate the notification buttons 616, 618 using updates to the cross-agent context data provided by the orchestrator agent. The orchestrator agent manages the communications with the various task agents to ensure consistency and security of the sharing of cross-agent context data across all of the agents in the multi-agent system.

The examples shown in FIG. 4, FIG. 5, and FIG. 6, and the accompanying description, are provided for illustration purposes. The illustrative examples are adaptable to smaller form factors such as smart phones, tablet computers, or wearable devices, and/or the user interfaces are adaptable to other forms of electronic devices, such as desktop computers and/or laptop devices, or vice versa. This disclosure is not limited to the described examples.

FIG. 7 is a flow diagram of an example method for cross-agent management in accordance with some examples of the present disclosure.

The method 700 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, portions of the method 700 are performed by one or more of the computing system components shown in FIG. 1, FIG. 2, FIG. 3, FIG. 4, FIG. 5, FIG. 6, one or more components of computing system 800 of FIG. 8, one or more components of FIG. 9A-9E, and/or one or more components of computer system 1000 of FIG. 10. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

At operation 710, the processing device maps input to a first task executable by a first task agent of a multi-agent application system. In some examples, the input is received at an orchestrator agent of the multi-agent application system via a first device. In some examples, the mapping is performed by an orchestrator agent, e.g., by a cross-agent context manager such as described with reference to FIG. 1 and/or FIG. 2.

In some examples, the first task is to detect anomalous accounts in a social network service, where individual ones of the communications are associated with individual accounts of a social network service, and where the output generated by the first task agent includes detection of an anomalous one of the accounts and the output automatically triggers isolation of the anomalous one of the accounts.

In some examples, mapping the input to the first task includes obtaining second cross-agent context data from the multi-layer memory and determining the first task using the input and the second cross-agent context data. In some examples, the second cross-agent context data includes an interaction history. In some examples, determining the first task is performed by an orchestrator agent, e.g., by a cross-agent context manager such as described with reference to FIG. 1 and/or FIG. 2.

In some examples, the processing device obtains a subset of the user interactions from the multi-layer memory; and via the second device, includes the subset of the user interactions in the response. In some examples, including the subset of user interactions in the response provides a user with a presentation of the user's message history with the orchestrator agent.

In some examples, the processing device obtains a first subset of the user interactions with the multi-agent application system via a first channel operated via the orchestrator agent; obtains a second subset of the user interactions with the multi-agent application system via a second channel; and stores machine learning-based representations of both the first subset and the second subset of the user interactions in the second layer of the multi-layer memory accessible to the orchestrator agent. In some examples, the first channel enables interaction with the multi-agent system and the second channel enables interaction with another application, system, or device. In some examples, the first and second channels are accessible via a multi-channel device interface. In some examples, machine learning-based representation services are used to create the machine learning-based representations.

In some examples, the processing device determines a presentation standard associated with the orchestrator agent; formulates the output generated by the first task agent according to the presentation standard; and includes the formulated output in the response. In some examples, a cross-agent presentation manager is used to prepare the formulated output, e.g., as described with reference to FIG. 1 and/or FIG. 2.

In some examples, the processing device determines a performance threshold associated with the orchestrator agent; determines that performance of a third task agent of the multi-agent application system is below the performance threshold; and excludes output generated by the third task agent from the response. In some examples, a cross-agent presentation manager is used to evaluate the performance of task agents and prepare the response, e.g., as described with reference to FIG. 1 and/or FIG. 2.

In some examples, the processing device routes the first task to task agents of the multi-agent application system including the first task agent; provides the first cross-agent context data to the plurality of task agents; receives, from respective task agents of the plurality of task agents, outputs generated via execution of the first task by the respective task agents using the first cross-agent context data; evaluates the respective outputs of the plurality of task agents using an evaluation threshold, the input, and the first task; and includes a subset of the outputs that meet or exceed the evaluation threshold in the response. In some examples, an orchestrator agent performs task to task agent routing and a cross-agent presentation manager is used to evaluate the respective outputs of task agents, e.g., as described with reference to FIG. 1 and/or FIG. 2.

In some examples, the user interactions with the multi-agent application system via the orchestrator agent comprise, for a user, interaction streams across multiple session, multiple devices, or multiple sessions and multiple devices, and the processing device uses the second memory layer to synchronize the interaction streams. In some examples, communication services and/or event streaming services are used to monitor interaction streams, e.g., as described with reference to FIG. 1 and/or FIG. 2.

In some examples, routing the first task to the first task agent includes formulating a generative machine learning model (GMLM) prompt including the input, the first task, and the first cross-agent context data; providing the prompt to the GMLM; receiving output from the GMLM in response to the prompt; and using the output from the GMLM to select the first task agent from a plurality of task agents of the multi-agent application system to perform the first task. In some examples, a prompt library and GMLM are used to route tasks to task agents, e.g., as described with reference to FIG. 1 and/or FIG. 2.

At operation 720, the processing device formulates a search using the input and the first task. In some examples, a cross-agent context manager and/or machine learning-based representation services are used to formulate the search, e.g., as described with reference to FIG. 1 and/or FIG. 2.

At operation 730, the processing device executes the search formulated at operation 720 on a second layer of a multi-layer memory accessible to the orchestrator agent. In some examples, the multi-layer memory includes a first layer and the second layer. In some examples, the first layer stores communications between the orchestrator agent and a second task agent of the multi-agent application system. In some examples, the communications relate to user interactions with the multi-agent application system via the orchestrator agent. In some examples, the second layer stores machine learning-based representations of the user interactions. In some examples, the multi-layer memory incudes memory layers, e.g., as described with reference to FIG. 2.

At operation 740, the processing device extracts, from results of the search, first cross-agent context data related to the input and the first task. In some examples, cross agent context data is extracted by a cross-agent context manager and/or machine learning-based representation services, e.g., as described with reference to FIG. 2.

At operation 750, the processing device routes the first task and the first cross-agent context data to the first task agent. In some examples, tasks and cross agent context data are routed to task agents by a cross-agent context manager and/or GMLM, e.g., as described with reference to FIG. 1 and/or FIG. 2.

At operation 760, the processing device receives, from the first task agent, output generated via execution of the first task by the first task agent using the first cross-agent context data. In some examples, output is received by a cross-agent presentation manager 114 or orchestrator agent, e.g., as described with reference to FIG. 1 and/or FIG. 2.

At operation 770, the processing device, via a second device, provides a response to the input. In some examples, the response includes the output generated by the first task agent using the first cross-agent context data generated by the second task agent. In some examples, the second device is different from the first device. A first device is an input device and a second device is an output device, in some examples. In some examples, responses are provided to one or more components of an environment via a multi-channel device interface, using a cross-agent presentation manager 114 or orchestrator agent, e.g., as described with reference to FIG. 1 and/or FIG. 2.

The examples shown in FIG. 7 and the accompanying description are provided for illustration purposes. This disclosure is not limited to the described examples.

FIG. 8 is a block diagram of a computing system that includes an agent system in accordance with some examples of the present disclosure.

In the example of FIG. 8, a computing system 800 includes one or more user systems 810, a network 820, an application system 830, data resources and tools 850, an agent system 880, a data storage system 860, an event logging service 870, and an AI model service 890.

All or at least some components of agent system 880 are implemented at the user system 810, in some examples. For example, portions of agent system 880 are implemented directly upon a single client device such that communications involving applications running on user system 810 and agent system 880 occur on-device without the need to communicate with, e.g., one or more servers, over the Internet. Dashed lines are used in FIG. 8 to indicate that all or portions of agent system 880 are capable of being implemented directly on the user system 810, e.g., the user's client device. In some examples, both user system 810 and agent system 880 are implemented on the same computing device, in some examples. In other examples, all or portions of agent system 880 are implemented on one or more servers and in communication with user systems 810 via network 820. Components of the computing system 800 including the agent system 880 are described in more detail herein.

A user system 810 includes one or more computing devices. Examples of computing devices include a personal computing device, a server, a mobile computing device, a wearable electronic device, or a smart appliance. The user system 810 includes one or more software applications that a computing device is capable of executing alone or in combination with one or more other computing devices. Examples of software applications include an operating system or a front end of an online system. Many different user systems 810 are capable of being connected to network 820 at the same time or at different times. In some examples, different user systems 810 contain similar components as described in connection with the illustrated user system 810. In some examples, many different end users of computing system 800 interact with many different instances of application system 830 through their respective user systems 810, at the same time or at different times.

User system 810 includes a user interface 812. User interface 812 is installed on user system 810 or accessible to user system 810 via network 820. In some examples, user interface 812 includes a front end portion of a search application or agent system.

User interface 812 includes, for example, a graphical display screen that includes graphical user interface elements. Examples of graphical user interface elements include an input box or other input mechanism and a slot. A slot as used herein refers to a space on a graphical display such as a web page or mobile device screen, into which output, e.g., digital content such as search results, feed items, chat boxes, or threads, is loaded for display to the user. In some examples, user interface 812 includes a scrollable arrangement of variable-length slots that simulates an online chat or instant messaging session and/or a scrollable arrangement of slots that contain content items or search results. The locations and dimensions of a particular graphical user interface element on a screen are specified using, for example, a markup language such as HTML (Hypertext Markup Language). On a typical display screen, a graphical user interface element is defined by two-dimensional coordinates. In other examples such as virtual reality or augmented reality examples, a slot is defined using a three-dimensional coordinate system. Example screen captures of user interface screens that are capable of being included in user interface 812 are shown in the drawings and described herein.

User interface 812 is capable of interacting with the agent system 880 and/or one or more application systems 830. For example, user interface 812 enables the user of a user system 810 to interact with the agent system 880 to create, edit, send, view, receive, process, and organize projects, tasks, plans, search queries, search results, content items, news feeds, and/or portions of online dialogs. In some examples, user interface 812 enables the user to input requests (e.g., queries) for various different types of information, to initiate user interface events, and to view or otherwise perceive output such as data and/or digital content produced by, e.g., an application system 830, agent system 880, content distribution service 838 and/or search engine 840. In some examples, user interface 812 includes a graphical user interface (GUI), a conversational voice/speech interface, a virtual reality, augmented reality, or mixed reality interface, and/or a haptic interface. User interface 812 includes a mechanism for entering search queries and/or selecting search criteria (e.g., facets, filters, etc.), selecting GUI user input control elements, and interacting with digital content such as search results, entity profiles, posts, articles, feeds, and online dialogs, in some examples. Some examples of user interface 812 include web browsers, command line interfaces, and mobile app front ends. User interface 812 as used herein includes application programming interfaces (APIs) in some examples.

Network 820 includes an electronic communications network. Network 820 is implemented on any medium or mechanism that provides for the exchange of digital data, signals, and/or instructions between the various components of computing system 800. Examples of network 820 include, without limitation, a Local Area Network (LAN), a Wide Area Network (WAN), an Ethernet network or the Internet, or a terrestrial, satellite or wireless link, or a combination of any number of different networks and/or communication links.

Application system 830 includes, for example, one or more online systems that provide social network services, general-purpose search engines, specific-purpose search engines, messaging systems, content distribution platforms, e-commerce software, enterprise software, or any combination of any of the foregoing or other types of software. Application system 830 includes any type of application system that provides or enables the retrieval of and interactions with one or more forms of digital content, including machine-generated content via user interface 812. In some examples, portions of agent system 880 are components of application system 830. In some examples, an application system 830 includes one or more of an entity graph 832 and/or knowledge graph 834, a user connection network 15315, a content distribution service 838, and/or a search engine 840. In other examples, application system 830 interacts with agent system 880 to control a physical machine or device, such as a vehicle or a robot.

In some examples, a front end portion of application system 830 operates in user system 810, for example as a plugin or widget in a graphical user interface of a web application, mobile software application, or as a web browser executing user interface 812. In an example, a mobile app or a web browser of a user system 810 transmits a network communication such as an HTTP request over network 820 in response to user input that is received through a user interface provided by the web application, mobile app, or web browser, such as user interface 812. A server running application system 830 receives the input from the web application, mobile app, or browser executing user interface 812, performs one or more operations using the input, and returns output to the user interface 812 using a network communication such as an HTTP response, which the web application, mobile app, or browser receives and processes at the user system 810.

In the example of FIG. 8, an application system 830 includes an entity graph 832 and/or a knowledge graph 834. Entity graph 832 and/or knowledge graph 834 include data organized according to graph-based data structures that are searchable or traversable via queries and/or indexes to determine relationships between entities. In some examples, entity graph 832 and/or knowledge graph 834 is used to compute various types of relationship weights, affinity scores, similarity measurements, and/or statistics between, among, or relating to entities.

Entity graph 832, knowledge graph 834 includes a graph-based representation of data stored in data storage system 860, described herein. For example, entity graph 832, knowledge graph 834 represents entities, such as users, organizations (e.g., companies, schools, institutions), content items (e.g., job postings, announcements, articles, comments, and shares), and computing resources (e.g., databases, models, applications, and services), as nodes of a graph. Entity graph 832, knowledge graph 834 represents relationships, also referred to as mappings or links, between or among entities as edges, or combinations of edges, between the nodes of the graph. In some examples, mappings between different pieces of data used by an application system 830 are represented by one or more entity graphs. In some examples, the edges, mappings, or links indicate relationships, online interactions, or activities relating to the entities connected by the edges, mappings, or links. In some examples, if a user clicks on a search result, an edge is created connecting the user entity with the search result entity in the entity graph, where the edge is tagged with a label such as “viewed.” If a user viewing a list of search results skip over a search result without clicking on the search result, an edge is not created between the user entity and the search result entity in the entity graph, in some examples.

Portions of entity graph 832, knowledge graph 834 are automatically re-generated or updated from time to time based on changes and updates to the stored data, e.g., updates to entity data and/or activity data. In some examples, entity graph 832, knowledge graph 834 refers to an entire system-wide entity graph or to only a portion of a system-wide graph. In some examples, entity graph 832, knowledge graph 834 refers to a subset of a system-wide graph, where the subset pertains to a particular user or group of users of application system 830.

Knowledge graph 834 includes a graph-based representation of data stored in data storage system 860, described herein. Knowledge graph 834 represents relationships, also referred to as links or mappings, between entities or concepts as edges, or combinations of edges, between the nodes of the graph. In some examples, mappings between different pieces of data used by application system 830 or across multiple different application systems are represented by the knowledge graph 834.

In some examples, knowledge graph 834 is a subset or a superset of entity graph 832. In some examples, knowledge graph 834 includes multiple different entity graphs 832 that are joined by cross-application or cross-domain edges. In some examples, knowledge graph 834 joins entity graphs 832 that have been created across multiple different databases or across different software products. In some examples, the entity nodes of the knowledge graph 834 represent concepts, such as product surfaces, verticals, or application domains. In some examples, knowledge graph 834 includes a platform that extracts and stores different concepts that is used to establish links between data across multiple different software applications. Examples of concepts include topics, industries, and skills. As with other portions of entity graph 832, knowledge graph 834 is usable to compute various types of relationship weights, affinity scores, similarity measurements, and/or statistical correlations between or among entities and/or concepts.

In the example of FIG. 8, application system 830 includes a user connection network 836. User connection network 836 includes, for instance, a social network service, professional social network system and/or other social graph-based applications. Content distribution service 838 includes, for example, a feed, chatbot or chat-style system, or a messaging system, such as a peer-to-peer messaging system that enables the creation and exchange of messages between users of application system 830 and the application system 830. Search engine 840 includes a search engine that enables users of application system 830 to input and execute search queries to retrieve information from one or more sources of information, such as user connection network 836, entity graph 832, knowledge graph 834, one or more data stores of data storage system 860, or one or more data resources and tools 850.

In the example of FIG. 8, application system 830 includes a content distribution service 838. The content distribution service 838 includes a data storage service, such as a web server, which stores digital content items, and transmits digital content items to users via user interface 812. In some examples, content distribution service 838 processes requests from, for example, application system 830 and/or agent system 880, and distributes digital content items to user systems 810 in response to requests.

A request includes, for example, a network message such as an HTTP (HyperText Transfer Protocol) request for a transfer of data from an application front end to the application's back end, or from the application's back end to the front end, or, more generally, a request for a transfer of data between two different devices or systems, such as data transfers between servers and user systems. A request is formulated, e.g., by a browser or mobile app at a user device, in connection with a user interface event such as a login, click on a graphical user interface element, an input of a search query, or a page load. In some examples, content distribution service 838 is part of application system 830. In other examples, content distribution service 838 interfaces with application system 830 and/or agent system 880, for example, via one or more application programming interfaces (APIs).

In the example of FIG. 8, application system 830 includes a search engine 840. Search engine 840 includes a software system designed to search for and retrieve information by executing queries on one or more data stores, such as databases, connection networks, and/or graphs. The queries are designed to find information that matches specified criteria, such as keywords and phrases contained in user input and/or system-generated queries. For example, search engine 840 is used to retrieve data in response to user input and/or system-generated queries, by executing queries on various data stores of data storage system 860 and/or data resources and tools 850, or by traversing entity graph 832, knowledge graph 834.

Data resources and tools 850 include computing resources, such as data stores, databases, embedding-based retrieval mechanisms, code generators, etc., that are capable of being used to operate an agent or agent system. Data resources and tools 850 include computing resources that are internal to application system 830 or external to application system 830. Examples of data resources and tools 850 include entity graphs, knowledge graphs, indexes, databases, networks, applications, models (e.g., large language models and/or other artificial intelligence models or machine learning models), taxonomies, data services, web pages, vectors (e.g., data stores that store embeddings), and searchable digital catalogs. Each data resource or tool 850 enables an agent or agent system to access the data resource or tool, for example by providing an application programming interface (API). Each data resource or tool 850 includes a monitoring service that periodically generates, publishes, or broadcasts availability and/or other performance metrics associated with the data resource, in some examples. A data resource or tool 850 provides a set of APIs that are used by an agent or agent system to access the data resource or tool, obtain output from the data resource, and/or obtain performance metrics for the data resource or tool, in some examples.

Data storage system 860 includes data stores and/or data services that store digital data received, used, manipulated, and produced by application system 830 and/or agent system 880, including contextual data, state data, prompts and/or prompt templates for generative artificial intelligence models or large language models, user inputs, system-generated outputs, metadata, attribute data, activity data. Databases or data stores that are capable of being used in some of the described examples include but are not limited to vector databases, graph databases, relational databases, and key-value stores.

In the example of FIG. 8, data storage system 860 includes various data stores that store, for example, entity data, context data, prompts, embeddings, etc. A data store includes include a volatile memory such as a form of random access memory (RAM) and/or persistent memory, which can be available on user system 810 or another device (e.g., one or more servers) for storing state data generated at the user system 810 or an application system 830. In some examples, a separate, personalized version of each or any data store is created for each user such that data is not shared between or among the separate, personalized versions of the data stores.

In some examples, data storage system 860 includes multiple different types of data storage and/or a distributed data service. In some examples, data service refers to a physical, geographic grouping of machines, a logical grouping of machines, or a single machine. In some examples, a data service includes a data center, a cluster, a group of clusters, or a machine. Data stores of data storage system 860 are capable of storing data produced by real-time and/or offline (e.g., batch) data processing. A data store configured for real-time data processing is referred to as a real-time data store, in some examples. A data store configured for offline or batch data processing is referred to as an offline data store, in some examples. Data stores are capable of being implemented using databases, such as key-value stores, relational databases, and/or graph databases. Data is written to and read from data stores using query technologies, e.g., SQL or NoSQL.

Data storage system 860 resides on one or more persistent and/or volatile storage devices that reside within the same local network as other devices of computing system 800 and/or in a network that is remote relative to other devices of computing system 800. Thus, although depicted as being included in computing system 800, portions of data storage system 860 are part of computing system 800 or accessed by computing system 800 over a network, such as network 820, in some examples.

Event logging service 870 captures and records activity data generated during operation of application system 830 and/or agent system 880, including user interface events generated at user systems 810 via user interface 812, in real time, and formulates the user interface events and/or other network activity data into a data stream that is consumed by, for example, a stream processing system. Examples of network activity data include logins, page loads, dialog inputs, input of search queries or query terms, selections of facets or filters, clicks on search results or graphical user interface control elements, scrolling lists of search results, and social action data such as likes, shares, comments, and social reactions (e.g., “insightful,” “curious,” “like,” etc.). For instance, when a user of application system 830 via a user system 810 enters input or clicks on a user interface element, such as a workflow element, or a user interface control element such as a view, comment, share, or reaction button, or uploads a file, or inputs a query, or scrolls through a feed, etc., event logging service 870 fires an event to capture and store log data including an identifier, such as a session identifier, an event type, a date/timestamp at which the user interface event occurred, and possibly other information about the user interface event, such as the impression portal and/or the impression channel involved in the user interface event. Examples of impression portals and channels include, for example, device types, operating systems, and software platforms, e.g., web applications and mobile applications.

For instance, when a user enters input or reacts to system-generated output, such as a list of search results, event logging service 870 stores the corresponding event data in a log. Event logging service 870 generates a data stream that includes a record of real-time event data for each user interface event that has occurred. Event data logged by event logging service 870 is pre-processed and anonymized as needed so that it is capable of being used as context data to, for example, configure one or more instructions for one or more artificial intelligence models (e.g., large language models), or to modify weights, affinity scores, or similarity measurements that are assigned by the agent system to search results or data resources.

Agent system 880 includes any one or more of the components, features, or functions described herein with respect to an agent system. For example, agent system 880 includes components of a multi-agent system such as described with reference to FIG. 1, FIG. 2, FIG. 3, FIG. 4, FIG. 5, FIG. 6, and/or FIG. 7.

AI model service 890 includes one or more artificial intelligence-based models, such as large language models and/or other types of machine learning models including discriminative and/or generative models, neural networks, probabilistic models, statistical models, transformer-based models, and/or any combination of any of the foregoing. AI model service 890 enables automated agents and agent systems to access to these models, for example by providing one or more application programming interfaces (APIs). AI model service 890 includes a monitoring service that periodically generates, publishes, or broadcasts latency and/or other performance metrics associated with the models. In some examples, AI model service 890 provides a set of APIs that are used by an agent or agent system to obtain performance metrics for large language models and/or other machine learning models.

While not specifically shown, it should be understood that any of user system 810, application system 830, data resources and tools 850, data storage system 860, event logging service 870, agent system 880, and AI model service 890 includes an interface embodied as computer programming code stored in computer memory that when executed causes a computing device to enable bidirectional communication with any other of user system 810, application system 830, data resources and tools 850, data storage system 860, event logging service 870, agent system 880, and AI model service 890 using a communicative coupling mechanism. Examples of communicative coupling mechanisms include network interfaces, inter-process communication (IPC) interfaces and application program interfaces (APIs).

Each of user system 810, application system 830, data resources and tools 850, data storage system 860, event logging service 870, agent system 880, and AI model service 890 is implemented using one or more computing devices that are communicatively coupled to electronic communications network 820. Any of user system 810, application system 830, data resources and tools 850, data storage system 860, event logging service 870, agent system 880, and AI model service 890 are capable of being bidirectionally communicatively coupled by network 820. User system 810 as well as other different user systems (not shown) are bidirectionally communicatively coupled to application system 830 and/or agent system 880, in some examples.

Examples of users of user system 810 include an administrator or end user of application system 830 or agent system 880. User system 810 is configured to communicate bidirectionally with any of application system 830, data resources and tools 850, data storage system 860, event logging service 870, agent system 880, and AI model service 890 over network 820.

Terms such as component, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 810, application system 830, data resources and tools 850, data storage system 860, event logging service 870, agent system 880, and AI model service 890 are implemented using computer software, hardware, or software and hardware, and include combinations of automated functionality, data structures, and digital data, which are represented schematically in the figures. User system 810, application system 830, data resources and tools 850, data storage system 860, event logging service 870, agent system 880, and AI model service 890 are shown as separate elements in FIG. 15 for ease of discussion but, except as otherwise described, the illustration is not meant to imply that separation of these elements is required. The illustrated systems, services, and data stores (or their functionality) of each of user system 810, application system 830, data resources and tools 850, data storage system 860, event logging service 870, agent system 880, and AI model service 890 are capable of being divided over any number of physical systems, including a single physical computer system, and are capable of communicating with each other in any appropriate manner.

In the example of FIG. 10, portions of agent system 880 that are capable of being implemented on a front end system, such as one or more user systems, and portions of agent system 880 that are capable of being implemented on a back end system such as one or more servers, are collectively represented as agent system 1050 for ease of discussion only. In some examples, portions of agent system 880 are not required to be implemented all on the same computing device, in the same memory, or loaded into the same memory at the same time. In some examples, access to portions of agent system 880 is limited to different, mutually exclusive sets of user systems and/or servers. In some examples, a separate, personalized version of agent system 880 is created for each user of the agent system 880 such that data is not shared between or among the separate, personalized versions of the agent system 880.Certain portions of agent system 880 are capable of being implemented on user systems while other portions of agent system 880 are capable of being implemented on a server computer or group of servers. In some examples, one or more portions of agent system 880 are implemented on user systems. Agent system 880 is entirely implemented on user systems, e.g., client devices, in some examples. In some examples, a version of agent system 880 is embedded in a client device's operating system or stored at the client device and loaded into memory at execution time.

The examples shown in FIG. 8 and the accompanying description, above are provided for illustration purposes. This disclosure is not limited to the described examples.

FIG. 9A, FIG. 9B, FIG. 9C, FIG. 9D, and FIG. 9E are block diagrams of examples of machine learning models that are usable by and/or included in an agent system in accordance with some examples of the present disclosure.

FIG. 9A is a block diagram of a machine learning modeling system that is capable of being used by and/or included in an agent system in accordance with some examples of the present disclosure.

Machine learning models are computer-implemented structures that are capable of generating predictive output in response to raw input. A machine learning model includes a probabilistic or statistical algorithm that is configured to perform a specific predictive function through a training process that involves iteratively exposing the models to many samples of data and adjusting one or more model parameters until the models achieve a satisfactory prediction accuracy and reliability. The predictive accuracy and reliability of a machine learning model in relation to a particular task is dependent upon the training process and the data used in the training.

Machine learning systems include components and processes that perform data generation, model training, model evaluation (e.g., calibration and validation), and application. Data preparation includes obtaining and aggregating model input data. The preparation of training data includes labeling the aggregated data, in some examples. Training data includes structured data, unstructured data, text, multimodal data, or any combination of any of the foregoing. Model training includes setting values of hyperparameters, determining performance metrics, adjusting weights of the machine learning model in response to the training data, evaluating the performance metrics, and parameter tuning. Application includes applying the trained machine learning model to the real-world environment, e.g., in a specific use case using data not included in the training data (e.g., unlabeled data). The application phase is referred to as inferencing or inference time, in some examples.

In FIG. 9A, a machine learning modeling system 900 includes a machine learning model 906, a modeling and calibration subsystem 902, and a model validation subsystem 904. The machine learning model 906 is any type or combination of one or more machine learning models, such as any of the types of machine learning models shown in FIG. 9B, FIG. 9C, FIG. 9D, and FIG. 9E and/or any other types or combinations of machine learning models.

The modeling and calibration subsystem 902 receives model input, such as input feature sets, embeddings, digital content, or prompts. The model input is engineered to train the machine learning model 906 to perform one or more tasks, such as discriminative tasks like classification or scoring and/or generative tasks such as content generation tasks. Modeling and calibration subsystem 902 includes a data set creation component 903, a model training component 905, and a model calibration component 907.

Data set creation component 903 divides the model input, e.g., input feature sets, into one or more training data sets and one or more validation data sets, e.g., training data set 909 and validation data set 911. Model training component 905 and model calibration component 907 cooperatively execute a training process. In some examples, the training process causes the machine learning model 906 to develop, by iterative adjustments to weights or coefficients, a mathematical representation of the relationships between different items of data, such as relationships between different inputs (e.g., similarity estimates or estimates of user preferences), or relationships between inputs and categorical data such as classification labels, or relationships between inputs and outputs. The resulting trained model is used to generate predictive output (e.g., scores, labels, or other output) based on subsequent model input.

One or more different approaches are used to train the machine learning model 906, for example, supervised machine learning, semi-supervised machine learning, or unsupervised machine learning. In supervised machine learning, the set of training data includes indications of expected model output coupled with respective model input; for example, ground-truth labeled data samples. In some examples, an instance of training data for supervised learning includes a model input (e.g., a set of features) and an associated expected output (e.g., a classification label), where the expected output is human curated or machine-generated. In some examples, an instance of training data for supervised machine learning includes a digital image and a title or caption for the image that describes the contents of the image. In unsupervised machine learning, the training examples are unlabeled. In unsupervised machine learning, a machine learning algorithm such as a clustering algorithm is used to identify similarities among data samples and create clusters or groupings of similar data using one or more similarity criteria. In some examples, unsupervised learning is used to group digital content items, such as images, articles, or videos, into topics, where the topics are determined based on the features of the content items themselves rather than supplied by labels. Semi-supervised machine learning combines supervised and unsupervised machine learning, using both labeled and unlabeled data to train machine learning models.

Model training component 905 applies machine learning model 906 to training data set 909 iteratively and adjusts the value of one or more model parameters and/or feature coefficients of the machine learning model 906 based on the processing of the training data set 909 by the model 906 until the difference between the predicted model output generated by the machine learning model 906 and the expected model output evidenced by the training data set 909 satisfies (e.g., meets or exceeds) model performance criteria 908. When the model performance criteria 908 are satisfied, modeling and calibration subsystem 902 ends the model training process and produces a trained machine learning model 906.

Model validation subsystem 904 applies a model validation process to the trained machine learning model 906 produced by modeling and calibration subsystem 902. Model validation subsystem 904 uses the validation data set 911 to determine whether model validation criteria 910 are satisfied (e.g., met or exceeded). In some examples, the validation data set 911 is created by setting aside a portion of the training data set 909 until after training, such that the validation data set 911 is used to compare and evaluate the difference between the predictive output produced by the trained model to the expected model output evidenced by the set-aside portion of the training data set 909.

A validated machine learning model 906 is used for inferencing, e.g., to generate predictive output, e.g., labels, scores, or other content, in response to model input. Alternatively or in addition, the output produced by the validated machine learning model 906 is stored for future use (e.g., for access or lookup by one or more downstream processes, systems, or services).

There are many different types and configurations of machine learning models. Illustrative, nonlimiting examples of some of the different types of machine learning models are shown in FIG. 9B, FIG. 9C, FIG. 9D, and FIG. 9E, described below. The AIs, models, and AI model services described herein are capable of including or using any of the various types of machine learning models, including but not limited to one or more of the types of models shown in FIG. 9B, FIG. 9C, FIG. 9D, and FIG. 9E.

The examples shown in FIG. 9A and the accompanying description, above are provided for illustration purposes. This disclosure is not limited to the described examples.

FIG. 9B is a block diagram of a machine learning model that is capable of being used by and/or included in an agent system in accordance with some examples of the present disclosure.

In the example of FIG. 9B, a machine learning system 912 includes a machine learning model 915. Machine learning model 915 is or includes a probabilistic or statistical machine learning model that uses a modeling function 916 to model the relationship between model input 914 (e.g., input feature set X) and model output (e.g., Y, P (Y|X)).

In some examples, the machine learning model 915 is configured as a discriminative model such that the machine learning model 915 produces output that indicates the probabilistic or statistical likelihood of an output Y given an input X. Some examples of the machine learning model 915 are alternatively or additionally configured as a generative model. In some examples, a machine learning model performs both discriminative and generative tasks.

One illustrative example of a discriminative model is a logistic regression function. Mathematically, a simplified form of the logistic function is capable of being expressed as

$$P ( X ) = f ( x ) = \frac{1}{1 + {e}^{- ( {β}_{0} + {β}_{1} x )}} ,$$

where e is the exponential constant and β₀ and β₁ are feature coefficients. During training of the logistic regression model 915, logistic regression estimates the values of the coefficients in the linear combination based on the feature values in the training data set. The machine learning model 915 is configured (e.g., values of model parameters are adjusted) via training, calibration, and validation processes such as those described with reference to FIG. 9A.

The machine learning model 915 includes a modeling function 916. The modeling function 916 includes feature coefficients 917. The values of one or more of the feature coefficients 917 are established via machine learning model training, calibration, and validation processes based on training data sets and/or validation data sets.

In the logistic regression example, the feature coefficients 917 include a regression coefficient β for each feature input x (e.g., ƒ(i)=β₀+β₁x_{1,i}+ . . . . βₘx_{m,i}), where xᵢ is a particular item of the feature set and m is the number of feature inputs x in the input feature set X 914. The regression coefficient indicates the relative effect of the particular feature input x of the feature set X on the predicted outcome P(Y|X), e.g., a predicted label or score, based on the values of the feature inputs x in the feature set X 914. The values of the feature coefficients are initialized and adjusted during model training and calibration.

The machine learning model 915 also includes model hyperparameters 918. The values of hyperparameters 918 are selected or tuned at a global level and generally are not modified based on specific instances of training data. In the logistic regression example, model hyperparameters 918 include a penalty or regularization parameter (e.g., L1 or L2) and the C or regularization strength parameter. The penalty or regularization parameter is tunable to adjust model generalization error and regulate overfitting. The C or regularization strength parameter regulates overfitting in conjunction with the penalty. The model hyperparameters 918 is tuned using, for example, a hyperparameter tuning tool or hyperparameter optimization method.

Some examples of the machine learning model 915 are configured as a binary classifier or as a scoring model. In a binary classification mode, the output of the machine learning model 915 indicates whether the model input is or is not associated with a certain output (e.g., either 0 if the input is not mathematically likely to be associated with the output or 1 if the input is mathematically likely to be associated with the output), for a given set of input features. In a scoring mode, the output of the machine learning model 915 includes a score, which corresponds to a probability of the predicted output (e.g., a numerical value between zero and 1, inclusive).

The model input 914 (e.g., input feature set X) includes numerical features, categorical features, quantitative values, qualitative values, raw features, compressed representations of raw features (e.g., vector representations or embeddings, and/or other forms of digital content.

In response to an instance of features of feature set X, machine learning model 915 computes and outputs an estimated output P(Y|X) 919. The estimated output produced by machine learning model 915 based on an instance of features of feature set X 914 is in the form of a binary output or a score, in some examples. The output is stored in a data storage for subsequent lookup or provided to one or more downstream systems, processes, devices, frameworks, and/or services.

The machine learning model 915 is configured and implemented as a network service, in some examples. In some examples, the machine learning model 915 is configured using a machine learning library and an application programming interface (API), e.g., via an API call such as ML_library.model(p1, p2, . . . pn), where p indicates a parameter or argument of the call, such as a model hyperparameter or an input feature set identifier. Once configured, the machine learning model 915 and/or its output is hosted on one or more servers and/or data storage devices for accessibility to one or more requesting processes, systems, devices, frameworks, or services.

The examples shown in FIG. 9B and the accompanying description, above are provided for illustration purposes. This disclosure is not limited to the described examples.

FIG. 9C is a block diagram of a machine learning model that is capable of being used by and/or included in an agent system in accordance with some examples of the present disclosure.

A generative machine learning model (GMLM) or generative model uses artificial intelligence technology, e.g., machine learning, neural networks, to machine-generate digital content based on model inputs and the previously existing data with which the model has been trained. Whereas discriminative models are based on conditional probabilities P (y|x), that is, the probability of an output y given an input x, generative models capture joint probabilities P (x, y), that is, the likelihood of x and y occurring together. A generative language model is a particular type of GMLM that is capable of generating content in response to model input. The model input includes a task description, also referred to as a prompt. The task description includes instructions (e.g., natural language instructions such as “please generate a summary of these search results”) and/or examples of digital content (e.g., examples of summaries written using a particular writing style or tone). Portions of the task description are in the form of natural language text, such as a question or a statement, in some examples. Alternatively or in addition, a task description or prompt includes non-text forms of content, such as digital imagery and/or digital audio.

In the example of FIG. 9C, a machine learning system 920 includes a machine learning model 924. Machine learning model 924 is or includes a probabilistic or statistical machine learning model that uses a modeling function to model the likelihood of cooccurrence of input feature set X and output Y; e.g., the likelihood of X and Y occurring together. The machine learning model 924 is configured via training, calibration, and validation processes such as those described with reference to FIG. 9A. Some examples of the machine learning model 924 are alternatively or additionally configured as a discriminative model. In some examples, a machine learning model performs both discriminative and generative tasks.

The machine learning model 924 includes a modeling function 925. The modeling function 925 includes feature coefficients or weights 926. The values of one or more of the feature coefficients is established via machine learning model training, calibration, and validation processes based on training data sets and/or validation data sets. The machine learning model 924 also includes model hyperparameters 927. The values of model hyperparameters 927 are selected or tuned at a global level and generally are not modified based on specific instances of training data.

The model input 922 (e.g., input feature set X) includes numerical features, categorical features, quantitative values, qualitative values, raw features, compressed representations of raw features (e.g., vector representations or embeddings), and/or other forms of digital content.

In response to an instance of model input 922 (e.g., instance of feature set X), machine learning model 924 computes and outputs an estimated output P(X,Y) 928. The estimated output produced by machine learning model 924 based on a model input 922 is in the form of an input-output pair and a score or simply includes the highest scoring input-output pair. In some examples, the output is stored in a data storage for subsequent lookup or provided to one or more downstream systems, processes, devices, frameworks, and/or services.

The machine learning model 924 is configured and implemented as a network service, in some examples. The machine learning model 924 is configured using a machine learning library and an application programming interface (API), e.g., via an API call such as ML_library.model(p1, p2, . . . pn), where p indicates a parameter or argument of the call, such as a model hyperparameter or an input feature set identifier, in some examples. Once configured, the machine learning model 924 and/or its output are hosted on one or more servers and/or data storage devices for accessibility to one or more requesting processes, systems, devices, frameworks, or services.

The examples shown in FIG. 9C and the accompanying description, above are provided for illustration purposes. This disclosure is not limited to the described examples.

FIG. 9D is a block diagram of a machine learning model that is capable of being used by and/or included in an agent system in accordance with some examples of the present disclosure.

A specific example of a machine learning model is a deep neural network. Some machine learning models, such as multi-task models, include multiple interconnected deep neural networks. In the example of FIG. 9D, a machine learning system 930 includes a deep neural network 934. The deep neural network 934 is configured via training, calibration, and validation processes such as those described with reference to FIG. 9A. Some examples of the deep neural network 934 are configured as a discriminative model and/or a generative model. In some examples, a deep neural network 934 performs both discriminative and generative tasks.

In computer science, deep learning refers to a class of machine learning that uses computer-implemented neural networks to generate predictive output, where the neural networks have one or more internal (or hidden) layers between and in addition to an input layer and an output layer. Each layer in a deep neural network (or deep learning model) performs a set of computational operations on the input to that layer.

Each layer of the neural network includes a set of nodes that each apply an activation function to one or more portions of the input to that layer to produce an output. The activation function performs a nonlinear transformation of the input and sends its output to the next layer of the network. For example, if the output of the activation function is equal to or exceeds a threshold value, the node passes its output to the next layer, but if the output is less than the threshold value, the output passed to the next layer is zero or a null value. The type of activation function used at a node or layer is selected based on the particular predictive task for which the model is configured and/or based on the model architecture. Examples of activation functions include the SoftMax function (for multi-class classification), the sigmoid function (for internal layers), and rectifier functions (e.g., ramp, or Rectified Linear Unit (ReLU)).

The input layer of a deep neural network receives and processes the model input, which includes raw data and/or pre-processed data such as aggregations, derivations, embeddings or vector representations of raw data. In some examples, the output of a layer of the neural network is connected to and used as the input to one or more other layers, such that each layer of the deep learning model creates a different (e.g., progressively more highly processed) set of information relating to the original, raw input (e.g., producing a different representation of the raw input at each layer). Weights are applied to the output of each node of each layer before the output is propagated to the next layer. The weight values are adjusted so that the outputs of some nodes or layers influences the final output more or less than the outputs of other nodes or layers, in some examples. The output layer of the neural network produces the final predictive output, which is made accessible to one or more downstream models, applications, systems, operations, processes or services.

Backpropagation is an example of a method that is often used to train a neural network model. In a feedforward step, the training data is propagated from the input layer through the internal layers to the final output by computing each successive layer's outputs up to and including the final output. A loss function (or cost function, such as cross-entropy, log loss, or squared error loss, or a logistic function) is used to compute error for the final output, for example, based on a comparison of the difference between the output predicted by the model and the expected or target output to the error computed on a previous iteration. The model weights (or parameters or coefficients) are adjusted to reduce the error, iteratively, until the error falls within an acceptable range or the error stops changing by more than a threshold amount (e.g., the model converges). In backpropagation, these iterative weight adjustments are propagated backward from the output layer through the internal layers. The gradient of the loss function or gradient descent (e.g., stochastic gradient descent) is often used in backpropagation.

In some examples, recommendation systems use deep learning models to generate predictive output and use the predictive output to configure or control one or more downstream operations. In some examples, recommendation systems compute statistical or probabilistic predictions that are used to select, rank, or sort digital content items for presentation to users via electronic devices. Examples of downstream operations that are capable of using the predictive output of deep learning recommendation systems include news feeds, automated product recommendations, and automated connection (e.g., friend, follower, or contact) recommendations for online platforms such as social networks. Other examples include systems that support human decision making, such as systems that use artificial intelligence to generate recommendations for health care, financial services, training, education, and/or other fields or topics. Still other examples include control systems that use artificial intelligence to recommend courses of action to other components of automated systems in operational environments, such as “smart” vehicles, appliances, robots, and other automated devices.

In the example of FIG. 9D, the deep neural network 934 includes an input layer 935, one or more hidden layers 936, and an output layer 937. The input layer 935 receives one or more batches of model input 923 (e.g., input feature sets X). In some examples, the input layer 935 includes a number of nodes that corresponds to the number of input features in a given input feature set X. The output of the input layer 935 becomes the input to the one or more hidden layers 936. The output of the one or more hidden layers 936 becomes the input to the output layer 937. The output layer 937 outputs the final predictive output 938. In some examples, each of the layers of the deep neural network 934 is fully connected in the sense that the output of each node of each layer is connected to the input of each node of the next subsequent layer. In other examples, the deep neural network 934 includes portions that are not fully connected.

The deep neural network 934 is capable of being configured and implemented as a network service. In some examples, the deep neural network 934 is configured using a machine learning library and an application programming interface (API), e.g., via an API call such as ML_library.model(p1, p2, . . . pn), where p indicates a parameter or argument of the call, such as a model hyperparameter or an input feature set identifier. Once configured, the deep neural network 934 and/or its output are hosted on one or more servers and/or data storage devices for accessibility to one or more requesting processes, systems, devices, frameworks, or services.

The input feature set X includes numerical features, categorical features, quantitative values, qualitative values, raw features, compressed representations of raw features (e.g., vector representations or embeddings), natural language, and/or other forms of digital content. Embedding refers to a numerical representation of a set of features, in some examples. An embedding encodes information, e.g., a set of features associated with an entity and/or attribute, relative to an embedding space. Embeddings and embedding spaces are generated by artificial intelligence (AI) models. An embedding is often expressed as a vector, where each dimension of the vector includes a numerical value that is an integer or a real number (e.g., a floating point value). The numerical value assigned to a given dimension of the vector conveys information about the data represented by the embedding, relative to the embedding space, also referred to as a vector space. The embedding space (or vector space) includes all of the possible values of each dimension of the vector. The embedding space is defined by the way in which the AI model used to generate the vector has been trained and configured, including the training data used to train the AI model. In some examples, train as used herein refers to an iterative process of applying an AI algorithm to one or more sets of training data, analyzing the output of the AI model in comparison to expected model output using a loss function (also referred to as a cost function or error function), adjusting values of one or more parameters and/or coefficients of the AI model, and repeating the process until the difference between the actual model output and the expected model output falls within an acceptable range of error or tolerance.

Embedding-based retrieval (EBR) is a method of searching for similar digital content, such as documents or portions of documents. Embedding-based retrieval involves converting digital data, e.g., sets of features, to embeddings and then using a similarity algorithm, such as nearest-neighbor search or cosine similarity, to identify embeddings that are similar to one another. Match or map refers to an exact match or an inexact match, in various examples. Match or map refers to a machine-determined predicted or estimated degree of relevance, similarity or compatibility between entities or data items that satisfies (e.g., meets or exceeds) a threshold level of relevance, similarity or compatibility, where the threshold level of relevance, similarity or compatibility is variable based on the requirements of a particular design or implementation. The threshold level of relevance, similarity, or compatibility is set lower or higher for different types of matching or mapping, in some examples.

In response to an instance of feature set X, deep neural network 934 computes and outputs a predictive output 938. The predictive output 938 is stored in a data storage for subsequent lookup or provided to one or more downstream systems, processes, devices, frameworks, and/or services.

The deep neural network 934 is configured and implemented as a network service, in some examples. The deep neural network 934 is configured using a machine learning library and an application programming interface (API), e.g., via an API call such as ML_library.model(p1, p2, . . . pn), where p indicates a parameter or argument of the call, such as a model hyperparameter or an input feature set identifier, in some examples. Once configured, the machine learning model 906 and/or its output are hosted on one or more servers and/or data storage devices for accessibility to one or more requesting processes, systems, devices, frameworks, or services.

The examples shown in FIG. 9D and the accompanying description, above are provided for illustration purposes. This disclosure is not limited to the described examples.

FIG. 9E is a block diagram of a machine learning model that is capable of being used by and/or included in an agent system in accordance with some examples of the present disclosure.

A specific example of a deep neural network is a sequence to sequence model, which takes sequential data such as words, phrases, or images (sequences of characters, tokens, or pixel values) or time series data as input and outputs sequential data. An example of a sequence to sequence model is an encoder-decoder model. In an encoder-decoder model, a first neural network known as an encoder transforms the model input into an encoded version of the model input, e.g., an embedding or vector. In some examples, an encoder transforms a sentence or an image into a sequence of numbers. A second neural network known as the decoder takes the output of the encoder (e.g., the encoded version of the model input) and decodes it. In some examples, a decoder transforms the sequence of numbers created and output by the encoder into a translated sentence or another form of output.

A specific example of an encode-decoder model is a transformer model. A transformer model is a deep neural network encoder-decoder model that uses a technique called attention or self-attention to detect relationships and dependencies among data elements in a sequence. Transformer models are capable of being used to perform various natural language processing (NLP) tasks and other machine learning tasks, such as generating content based on input attributes or tokens. In some examples, the attention mechanism facilitates the detection of relationships and dependencies between words and phrases.

In the example of FIG. 9E, a machine learning system 940 includes a transformer model 942. The transformer model 942 is constructed using a neural network-based machine learning model architecture. In some examples, the neural network-based architecture includes one or more self-attention layers (e.g., multi-head attention layer 945, masked multi-head attention layer 955, and multi-head attention layer 957) that allow the model to assign different weights to different features included in the model input. Alternatively, or in addition, the neural network architecture includes feed-forward layers (e.g., feed-forward layer 947 and feed-forward layer 959) and residual connections (e.g., add & norm layer 946, add & norm layer 948, add & norm layer 956, add & norm layer 958, add & norm layer 960) that allow the model to machine-learn complex data patterns including relationships between different states, actions, and rewards in multiple different contexts. In some examples, transformer model 942 is constructed using a transformer-based architecture that includes self-attention layers, feed-forward layers, and residual connections between the layers. The exact number and arrangement of layers of each type as well as the hyperparameter values used to configure the model are determined based on the requirements of a particular design or implementation of the user trajectory processing system.

As shown in FIG. 9E, transformer model 942 feeds embedded subsequences 950 into encoder 944 and decoder 954. For example, transformer model 942 feeds inputs of embedded subsequences 950 into multi-head attention layer 945 of encoder 944. In some examples, inputs of embedded subsequences 950 are a series of tokens and the output of the encoder (e.g., encoder output representation 952), is a fixed-dimensional representation for each of the tokens of embedded subsequences 950 including an embedding for inputs of embedded subsequences 950. Transformer model 942 feeds encoder output representation 952 and outputs of embedded subsequences 950 into decoder 954 which generates a sequence of tokens based on encoder output representation 952 and the input embeddings. While a specific architecture of encoder 944 and decoder 954 is shown for simplicity, as explained above, the exact number and arrangement of layers of each type as well as the hyperparameter values used to configure the model are determined based on the requirements of a particular design or implementation. Therefore, in some examples, transformer model 942 includes different numbers, arrangements, and types of layers, such that each input token of embedded subsequences 950 is fed through the layers of transformer model 942 and is dependent on other input tokens of embedded subsequences 950.

Transformer model 942 illustrates a generic encoder/decoder model for simplicity. In such a model, encoder 944 encodes the input into a fixed-length vector (e.g., encoder output representation 952) and decoder 954 decodes the fixed-length vector into an output sequence. Encoder 944 and decoder 954 are trained together to maximize the conditional log-likelihood of the output given the input. Once trained, encoder 944 and decoder 954 are capable of generating output given an input sequence or scoring a pair of input-output sequences based on their probability of coexistence.

As shown in FIG. 9E, encoder 944 includes multi-head attention layer 945, add & norm layer 946, feed-forward layer 947, and add & norm layer 948. Multi-head attention layer 945 receives inputs of embedded subsequences 950 and computes output representations for each of the input tokens of embedded subsequences 950 based on the inputs of embedded subsequences 950. For example, multi-head attention layer 945 converts each input token of embedded subsequences 950 into queries, keys, and values using query, key, and value matrices. Multi-head attention layer 945 computes the output representation of the input tokens of embedded subsequences 950 as the weighted sum of the values of all of the input tokens of embedded subsequences 950. Multi-head attention layer 945 computes the weights for the weighted sum by applying a compatibility function to the corresponding key and query for the value. For example, multi-head attention layer 945 uses a scaled dot product on the key and query of an input token to determine a weight to apply to a value of the input token. Multi-head attention layer 945 includes multiple attention blocks which each compute an output representation for the input token. Multi-head attention layer 945 aggregates the output representations of these attention blocks to generate a final output representation for multi-head attention layer 945.

Transformer model 942 feeds the output representation generated by multi-head attention layer 945 and residual connections from the inputs of embedded subsequences 950 into add & norm layer 946. By including these residual connections, transformer model 942 ensures that it does not “forget” features of embedded subsequences 950 during training. Forgetting in the context of machine learning refers to a phenomenon that occurs as the model continues to be sequentially trained on different datasets over time. Because the model continually adjusts the values of feature coefficients as it is trained on subsequent training datasets, these continuous adjustments of the feature coefficient values is capable of causing the influence of the datasets used earlier in training on those coefficient values to be lost or diluted.

Add & norm layer 946 sums the output representation generated by multi-head attention layer 945 and the residual connections from inputs of embedded subsequences 950 and applies a layer normalization to the result. In some examples, the add & normal layers also apply a SoftMax function to generate action probabilities for the inputs of embedded subsequences 950. For example, add & norm layer 946 generates estimated probabilities \hat{p}(aₖ|s), where aₖ is the action policy and s is the state features.

Transformer model 942 feeds the normalized output of add & norm layer 946 into feed-forward layer 947. Feed-forward layer 947 is a feed-forward network that receives the normalized output, feeds it through the hidden layers of feed-forward layer 947, and then feeds the output of feed-forward layer 947 into add & norm layer 948. Feed-forward layer 947 processes the information received from add & norm layer 946 and updates the hidden layers of feed-forward layer 947 based on the information (e.g., during training) and/or generate an output based on the hidden layers processing the information (e.g., during evaluation and/or inference). For example, during training, transformer model 942 updates the weights of the hidden layers of feed-forward layer 947 based on the inputs and the loss of the transformer system. Further details with regard to the loss of the transformer system as well as training objectives and metrics are discussed below. As an alternative example, during evaluation and/or inference, the weights of the hidden layers of feed-forward layer 947 are used to determine the output representation 952 of each of the input tokens of embedded subsequences 950.

Transformer model 942 feeds the output of feed-forward layer 947 into add & norm layer 948 as well as residual connections from the output of add & norm layer 946. Add & norm layer 948 sums the output of feed-forward layer 947 with the residual connections from add & norm layer 946 and applies a layer normalization to the result to generate encoder output representation 952. Transformer model 942 feeds encoder output representation 952 into multi-head attention layer 957 of decoder 954 as explained below.

Masked multi-head attention layer 955 receives outputs of embedded subsequences 950 and computes representations for each of the output tokens of embedded subsequences 950 based on masked outputs of embedded subsequences 950. For example, masked multi-head attention layer 955 computes representations for each of the output tokens of embedded subsequences 950 based on previous output tokens while masking future output tokens. Masked multi-head attention layer 955 therefore only computes representations using tokens that come before the token masked multi-head attention layer 955 is trying to predict.

Transformer model 942 feeds the representation generated by masked multi-head attention layer 955 and residual connections from the outputs of embedded subsequences 950 into add & norm layer 956. Add & norm layer 956 sums the representation generated by masked multi-head attention layer 955 and the residual connections from outputs of embedded subsequences 950 and applies a layer normalization to the result.

Transformer model 942 feeds the normalized output of add & norm layer 956 into multi-head attention layer 957. Multi-head attention layer 957 receives the normalized output of add & norm layer 956 as well as encoder output representation 952 from encoder 944 and generates a representation based on both.

Transformer model 942 feeds the representation generated by multi-head attention layer 957 and residual connections from the output of add & norm layer 956 into add & norm layer 958. Add & norm layer 958 sums the representation generated by multi-head attention layer 957 and the residual connections from the output of add & norm layer 956 and applies a layer normalization to the result.

Transformer model 942 feeds the normalized output of add & norm layer 958 into feed-forward layer 959. Feed-forward layer 959 is a feed-forward network that receives the normalized output, feeds it through the hidden layers of feed-forward layer 959, and then feeds the output of feed-forward layer 959 into add & norm layer 969. Feed-forward layer 959 processes the information received from add & norm layer 958 and updates the hidden layers of feed-forward layer 959 based on the information (e.g., during training) and/or generate an output based on the hidden layers processing the information (e.g., during evaluation and/or inference). For example, during training, transformer model 942 updates the weights of the hidden layers of feed-forward layer 959 based on the inputs and the loss of the transformer system. Further details with regard to the loss of the transformer system as well as training objectives and metrics are discussed below. As an alternative example, during evaluation and/or inference, the weights of the hidden layers of feed-forward layer 959 are used to determine the output of feed-forward layer 959.

Transformer model 942 feeds the output of feed-forward layer 959 into add & norm layer 960 as well as residual connections from the output of add & norm layer 958. Add & norm layer 960 sums the output of feed-forward layer 959 with the residual connections from add & norm layer 958 and applies a layer normalization to the result to generate an output.

Transformer model 942 generates output probabilities 962 from the output of add & norm layer 960. For example, transformer model 942 applies a linear transformation and a SoftMax function to the output of add & norm layer 960 to generate a normalized vector of output probabilities 962.

In some examples, such as during training, transformer model 942 determines a loss for the system based on output probabilities 962. In some examples, transformer model 942 uses deep quantile regression for training. In such an example, output probabilities 962 includes a mean prediction probability and estimations for the upper and lower bounds of the range of prediction such that output probabilities 626 includes an uncertainty range. In one example, the loss function of transformer model 942 using deep quantile regression is represented by the following equation:

$$ℒ ( {ξ}_{i} \vert α ) = \{ \begin{matrix}{αξ}_{i} if {ξ}_{i} \geq 0 , \\ ( α - 1 ) {ξ}_{i} if {ξ}_{i} < 0\end{matrix} ,$$

where α is the required quantile (a value between 0 and 1 representing the desired quantile) and ξᵢ=yᵢ−ƒ(xᵢ), where ƒ(xᵢ) is the mean predicted by output probabilities 962, yᵢ are the outputs of embedded subsequences 950 and xᵢ are the inputs of embedded subsequences 950. The loss over the entirety of a dataset of embedded subsequences 950 where embedded subsequences 950 has a length of N is capable of being represented by the following equation:

$$ℒ ( y , f \vert α ) = \frac{1}{N} {\sum }_{i = 1}^{N} ℒ ( {y}_{i} - f ( {x}_{i} ) \vert α ) .$$

In such examples, output probabilities 962 includes three values: a mean prediction, a lower bound quantile, and an upper bound quantile. In some examples, transformer model 942 uses upper confidence bound or Thompson sampling. In some examples, transformer model 942 determines model output 964 based on the mean prediction, the lower bound quantile, and the upper bound quantile based on upper confidence bound and/or Thompson sampling.

In some examples, transformer model 942 is trained to optimize the model parameters with trajectory-specific normalizations using cross-entropy loss. For example, transformer model 942 uses a loss function represented by the following equation:

$$L ( θ ) = \frac{1}{{N}_{traj}} {\sum }_{i}^{{N}_{traj}} {\sum }_{t = 1}^{{T}_{i}} {w}_{i} {\sum }_{k} log ( \hat{p} ( {a}_{k}^{( it )} \vert {s}^{( it )} ) ) ,$$

where Nₜᵣₐⱼ is the trajectory count, wᵢ is the normalization weight, αₖ^{(it)} is the predicted action for the trajectory i at timestep t, and s^{(it)} is the state of the online system for the trajectory i at timestep t. In some examples, transformer model 942 uses trajectory-wise normalization. In some examples, the add & norm layers of transformer model 942 normalize the weights according to the following equation:

$${w}_{i} = \frac{1}{{T}_{i}} ,$$

where Tᵢ is the length of trajectory i. In some examples, transformer model 942 uses global normalization. In some examples, the add & norm layers of transformer model 942 normalize the weights according to the following equation: wᵢ=c, where c is a positive scalar. In some examples, the scalar c is predetermined.

Language models, including large language models and other generative models, are capable of being implemented using transformer models. A generative model is commonly constructed using a neural network-based machine learning model architecture. In some examples, the neural network-based architecture includes one or more input layers that receive task descriptions (or prompts), generate one or more embeddings based on the task descriptions, and pass the one or more embeddings to one or more other layers of the neural network. In other examples, the one or more embedding are generated based on the task description by a pre-processor, the embeddings are input to the generative language model, and the generative language model outputs digital content, e.g., natural language text or a combination of natural language text and non-text output, based on the embeddings.

The neural network-based machine learning model architecture of the generative model often includes one or more self-attention layers that allow the model to assign different weights to different portions of the model input (e.g., different words or phrases included in the model input). Alternatively or in addition, the neural network architecture includes feed-forward layers and residual connections that allow the model to machine-learn complex data patterns including relationships between different words or phrases in multiple different contexts. The language model or other type of generative model is capable of being constructed using a transformer-based architecture that includes self-attention layers, feed-forward layers, and residual connections between the layers. The exact number and arrangement of layers of each type as well as the hyperparameter values used to configure the model are determined based on the requirements of a particular design or implementation.

In some examples, the neural network-based machine learning model architecture of a generative model includes or is based on one or more generative transformer models, one or more generative pre-trained transformer (GPT) models, one or more bidirectional encoder representations from transformers (BERT) models, one or more large language models (LLMs), one or more XLNet models, and/or one or more other natural language processing (NL) models that significantly advance the state-of-the-art in various linguistic tasks such as machine translation, sentiment analysis, question answering and sentence similarity. In some examples, the neural network-based machine learning model architecture includes or is based on one or more predictive content neural models that receive digital content input and generate one or more outputs based on processing the digital content with one or more neural network models. Examples of predictive neural models include, but are not limited to, Generative Pre-Trained Transformers (GPT), BERT, and/or Recurrent Neural Networks (RNNs). In some examples, one or more types of neural network-based machine learning model architecture includes or is based on one or more multimodal neural networks capable of outputting different modalities (e.g., text, image, sound, etc.) separately and/or in combination based on digital content input. Accordingly, in some examples, a multimodal neural network is capable of outputting digital content that includes a combination of two or more of text, images, video or sound.

A generative language model is capable of being trained on a large dataset of natural language text. In some examples, training samples of natural language text extracted from publicly available data sources are used to train a generative language model. The size and composition of the dataset used to train the generative language model are variable according to the requirements of a particular design or implementation. In some examples, the dataset used to train the generative language model includes hundreds of thousands to millions or more different natural language text training samples. In some examples, a generative language model includes multiple generative language models trained on differently sized datasets. In some examples, a generative language model includes a comprehensive but low capacity model that is trained on a large data set and used for generating examples. The same generative language model also includes a less comprehensive but high capacity model that is trained on a smaller data set, such that the high capacity model is used to generate outputs based on data obtained from the low capacity model. In some examples, reinforcement learning is used to further improve the output of the generative language model. In reinforcement learning, ground-truth examples of desired model output are paired with respective prompts, and these prompt-output pairs are used to train or fine tune the generative language model.

Prompt engineering is a technique used to optimize the structure and/or content of a prompt input to a generative model. Some prompts include examples of outputs to be generated by the generative model (e.g., few-shot prompts), while other prompts include no examples of outputs to be generated by the generative model (e.g., zero-shot prompts). Chain of thought prompting is a prompt engineering technique where the prompt includes a request that the model explain reasoning in the output. For example, the generative model performs the task described in the prompt using a series of steps and outputs reasoning as to each step performed.

Supervised learning is a method of training (or fine-tuning) a machine learning model given input-output pairs, where the output of the input-output pair is known (e.g., an expected output, a labeled output, a ground truth). Other training methods including semi-supervised learning or federated learning are capable of being used to train a machine learning model or to fine-tune a pretrained machine learning model.

The transformer model 942 is configured and implemented as a network service, in some examples. The transformer model 942 is configured using a machine learning library and an application programming interface (API), e.g., via an API call such as ML_library.model(p1, p2, . . . pn), where p indicates a parameter or argument of the call, such as a model hyperparameter or an input identifier. Once configured, the transformer model 942 and/or its output are hosted on one or more servers and/or data storage devices for accessibility to one or more requesting processes, systems, devices, frameworks, or services.

The examples shown in FIG. 9E and the accompanying description, above are provided for illustration purposes. This disclosure is not limited to the described examples.

FIG. 10 is a block diagram of an example computer system including components of an agent system in accordance with some examples of the present disclosure.

In FIG. 10, an example machine of a computer system 1000 is shown, within which a set of instructions for causing the machine to perform any of the methodologies discussed herein are capable of being executed. In some examples, the computer system 1000 corresponds to a component of a networked computer system (e.g., any one or more of the components shown in FIG. 1, FIG. 2, FIG. 3, FIG. 4, FIG. 5, FIG. 6, FIG. 7, FIG. 8, or FIG. 9A-9E) that includes, is coupled to, or utilizes a machine to execute an operating system to perform operations corresponding to any one or more components shown in FIG. 1, FIG. 2, FIG. 3, FIG. 4, FIG. 5, FIG. 6, FIG. 7, FIG. 8, or FIG. 9A-9E. For example, computer system 1000 corresponds to a portion of a computing system when the computing system is executing a portion of any one or more components shown in FIG. 1, FIG. 2, FIG. 3, FIG. 4, FIG. 5, FIG. 6, FIG. 7, FIG. 8, or FIG. 9A-9E.

The machine is connected (e.g., networked) to other machines in a network, such as a local area network (LAN), an intranet, an extranet, and/or the Internet. The machine operates in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 1000 includes a processing device 1002, a main memory 1004 (e.g., read-only memory (ROM), flash memory, dynamic random access memory (DRAM) such as synchronous DRAM (SDRAM) or Rambus DRAM (RDRAM), etc.), a memory 1003 (e.g., flash memory, static random access memory (SRAM), etc.), an input/output system 1010, and a data storage system 1040, which communicate with each other via a bus 1030.

Processing device 1002 represents one or more general-purpose processing devices such as a microprocessor, a central processing unit, or the like. In some examples, the processing device is a complex instruction set computing (CISC) microprocessor, reduced instruction set computing (RISC) microprocessor, very long instruction word (VLIW) microprocessor, or a processor implementing other instruction sets, or processors implementing a combination of instruction sets. In some examples, processing device 1002 includes a special-purpose processing device such as an application specific integrated circuit (ASIC), a field programmable gate array (FPGA), a digital signal processor (DSP), network processor, or the like. The processing device 1002 is to execute instructions 1012 for performing the operations and steps discussed herein.

In some examples of FIG. 10, agent system 1050 represents portions of agent system 880 while the computer system 1000 is executing those portions of agent system 880. Instructions 1012 include portions of agent system 1050 when those portions of the agent system 1050 are being executed by processing device 1002. Thus, the agent system 1050 is shown in dashed lines as part of instructions 1012 to illustrate that, at times, portions of the agent system 1050 are executed by processing device 1002. For example, when at least some portion of the agent system 1050 is embodied in instructions to cause processing device 1002 to perform the method(s) described herein, some of those instructions are read into processing device 1002 (e.g., into an internal cache or other memory) from main memory 1004 and/or data storage system 1040. In some examples, it is not required that all of the agent system 1050 be included in instructions 1012 at the same time and portions of the agent system 1050 are stored in another component of computer system 1000 at other times, e.g., when a portion of the agent system 1050 is not being executed by processing device 1002.

The computer system 1000 further includes a network interface device 1008 to communicate over the network 1020. Network interface device 1008 provides a two-way data communication coupling to a network. In some examples, network interface device 1008 includes an integrated-services digital network (ISDN) card, cable modem, satellite modem, or a modem to provide a data communication connection to a corresponding type of telephone line. In some examples, network interface device 1008 includes a local area network (LAN) card to provide a data communication connection to a compatible LAN. Wireless links are included, in some examples. Network interface device 1008 sends and receives electrical, electromagnetic, or optical signals that carry digital data representing various types of information.

The network link is capable of providing data communication through one or more networks to other data devices. In some examples, a network link provides a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 1000.

Computer system 1000 is capable of sending messages and receiving data, including program code, through the network(s) and network interface device 1008. In some examples, a server is capable of transmitting a requested code for an application program through the Internet and network interface device 1008. The received code is executed by processing device 1002 as it is received, and/or stored in data storage system 1040 or other non-volatile storage for later execution.

The input/output system 1010 includes an output device, such as a display, for example a liquid crystal display (LCD) or a touchscreen display, for displaying information to a computer user, or a speaker, a haptic device, or another form of output device. The input/output system 1010 includes an input device, for example, alphanumeric keys and other keys configured for communicating information and command selections to processing device 1002. An input device sometimes includes a cursor control, such as a mouse, a trackball, or cursor direction keys for communicating direction information and command selections to processing device 1002 and for controlling cursor movement on a display. An input device sometimes includes a microphone, a sensor, or an array of sensors, for communicating sensed information to processing device 1002. Examples of sensed information include voice commands, audio signals, geographic location information, haptic information, and/or digital imagery, for example.

The data storage system 1040 includes a machine-readable storage medium 1042 (also known as a computer-readable medium) on which is stored instructions 1044 or software embodying any of the methodologies or functions described herein. The instructions 1044 sometimes reside, completely or at least partially, within the main memory 1004 and/or within the processing device 1002 during execution thereof by the computer system 1000, the main memory 1004 and the processing device 1002 also constituting machine-readable storage media. In one example, the instructions 1044 include instructions to implement functionality corresponding to an automated agent or agent system (e.g., any one or more of the components shown in any one or more components shown in FIG. 1, FIG. 3, FIG. 4, FIG. 6, FIG. 7, FIG. 9A-9E, or agent system 880 of FIG. 8).

Dashed lines are used in FIG. 10 to indicate that it is not required that the agent system be embodied entirely in instructions 1012, 1014, and 1044 at the same time. In one example, portions of the agent system are embodied in instructions 1014, which are read into main memory 1004 as instructions 1014, and portions of instructions 1012 are read into processing device 1002 as instructions 1012 for execution. In another example, some portions of the agent system are embodied in instructions 1044 while other portions are embodied in instructions 1014 and still other portions are embodied in instructions 1012.

While the machine-readable storage medium 1042 is shown in an example to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media.

The examples shown in FIG. 10 and the accompanying description, above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure refers to actions and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations described herein. This apparatus is specially constructed for the intended purposes, in some examples. In other examples, the apparatus includes a general-purpose computer selectively activated or reconfigured by a computer program stored in the computer. In some examples, a computer system or other data processing system including any one or more of the components shown in FIG. 1, FIG. 2, FIG. 3, FIG. 4, FIG. 5, FIG. 6, FIG. 7, FIG. 8, FIG. 9A-9E and/or FIG. 10, carries out the above-described computer-implemented methods in response to its processor executing a computer program (e.g., a sequence of instructions) contained in a memory or other non-transitory machine-readable storage medium. Such a computer program is be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems are capable of being used. A more specialized apparatus is constructed, in some examples. Examples of structure for these systems are provided in the description. Aspects of this disclosure are not limited to any particular programming language. A variety of programming languages are usable to implement the various aspects of this disclosure.

Some examples of the present disclosure are provided as a computer program product, or software, which includes a machine-readable medium having stored thereon instructions, which is used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The techniques described herein are capable of being implemented with privacy safeguards to protect user privacy. Furthermore, the techniques described herein are capable of being implemented with user privacy safeguards to prevent unauthorized access to personal data and confidential data. The training of the AI models described herein is executed to benefit all users fairly, without causing or amplifying unfair bias.

According to some examples, the techniques for the models described herein do not make inferences or predictions about individuals unless requested to do so through an input. According to some examples, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users are capable of having full control over the visibility of their content and who sees their content, as is controlled via the visibility settings. According to the techniques described herein, users are capable of having full control over the level of their personal data that is shared and distributed between different AI platforms that provide different functionalities.

According to the techniques described herein, users are capable of choosing to share personal data with different platforms to provide services that are more tailored to the users. In instances where the users choose not to share personal data with the platforms, the choices made by the users will not have any impact on their ability to use the services that they had access to prior to making their choice.

According to the techniques described herein, users are capable of having full control over the level of access to their personal data that is shared with other parties. According to the techniques described herein, personal data provided by users is capable of being processed to determine prompts when using a generative AI feature at the request of the user, but not to train generative AI models. In some examples, users are capable of providing feedback while using the techniques described herein, which is capable of being used to improve or modify the platform and products. In some examples, any personal data associated with a user, such as personal information provided by the user to the platform, is deleted from storage upon user request. In some examples, personal information associated with a user is permanently deleted from storage when a user deletes their account from the platform.

According to the techniques described herein, personal data is capable of being removed from any training dataset that is used to train AI models. In some examples, the techniques described herein utilize tools for anonymizing member and customer data. A user's personal data is capable of being redacted and minimized in training datasets for training AI models through delexicalization tools and other privacy enhancing tools for safeguarding user data. The techniques described herein are capable of minimizing use of any personal data in training AI models, including removing and replacing personal data. In examples of the techniques described herein, notices are communicated to users to inform how their data is being used and users are provided controls to opt-out from their data being used for training AI models.

According to some examples, tools are used with the techniques described herein to identify and mitigate risks associated with AI in all products and AI systems. In some examples, notices are provided to users when AI tools are being used to provide features.

Illustrative examples of the technologies disclosed herein are provided below. An example of the technologies includes any of the examples described herein, or any combination of any of the examples described herein, or any combination of any portions of the examples described herein. In some aspects, the techniques described herein relate to a method including: mapping input to a first task executable by a first task agent of a multi-agent application system, wherein the input is received at an orchestrator agent of the multi-agent application system via a first device; formulating a search using the input and the first task; executing the search on a second layer of a multi-layer memory accessible to the orchestrator agent, wherein the multi-layer memory includes a first layer and the second layer, the first layer stores communications between the orchestrator agent and a second task agent of the multi-agent application system, wherein the communications relate to user interactions with the multi-agent application system via the orchestrator agent, and wherein the second layer stores machine learning-based representations of the user interactions; extracting, from results of the search, first cross-agent context data related to the input and the first task; routing the first task and the first cross-agent context data to the first task agent; receiving, from the first task agent, output generated via execution of the first task by the first task agent using the first cross-agent context data; and via a second device, providing a response to the input, wherein the response includes the output generated by the first task agent using the first cross-agent context data generated by the second task agent.

In some aspects, the techniques described herein relate to a method, wherein the first task is to detect anomalous accounts in a social network service, and wherein individual ones of the communications are associated with individual accounts of a social network service, and wherein the output generated by the first task agent includes detection of an anomalous one of the accounts and the output automatically triggers isolation of the anomalous one of the accounts.

In some aspects, the techniques described herein relate to a method, wherein mapping the input to the first task includes: obtaining second cross-agent context data from the multi-layer memory; and determining the first task using the input and the second cross-agent context data.

In some aspects, the techniques described herein relate to a method, further including: obtaining a subset of the user interactions from the multi-layer memory; and via the second device, including the subset of the user interactions in the response.

In some aspects, the techniques described herein relate to a method, further including: obtaining a first subset of the user interactions with the multi-agent application system via a first channel operated via the orchestrator agent; obtaining a second subset of the user interactions with the multi-agent application system via a second channel; and storing machine learning-based representations of both the first subset and the second subset of the user interactions in the second layer of the multi-layer memory accessible to the orchestrator agent.

In some aspects, the techniques described herein relate to a method, further including: determining a presentation standard associated with the orchestrator agent; formulating the output generated by the first task agent according to the presentation standard; and including the formulated output in the response.

In some aspects, the techniques described herein relate to a method, further including: determining a performance threshold associated with the orchestrator agent; determining that performance of a third task agent of the multi-agent application system is below the performance threshold; and excluding output generated by the third task agent from the response.

In some aspects, the techniques described herein relate to a method, further including: routing the first task to a plurality of task agents of the multi-agent application system including the first task agent; providing the first cross-agent context data to the plurality of task agents; receiving, from respective task agents of the plurality of task agents, outputs generated via execution of the first task by the respective task agents using the first cross-agent context data; evaluating the respective outputs of the plurality of task agents using an evaluation threshold, the input, and the first task; and including a subset of the outputs that meet or exceed the evaluation threshold in the response.

In some aspects, the techniques described herein relate to a method, wherein the user interactions with the multi-agent application system via the orchestrator agent include, for a user, interaction streams across multiple session, multiple devices, or multiple sessions and multiple devices, and the method further includes using the second memory layer to synchronize the interaction streams.

In some aspects, the techniques described herein relate to a method, wherein routing the first task to the first task agent includes: formulating a generative machine learning model (GMLM) prompt including the input, the first task, and the first cross-agent context data; providing the prompt to the GMLM; receiving output from the GMLM in response to the prompt; and using the output from the GMLM to select the first task agent from a plurality of task agents of the multi-agent application system to perform the first task.

In some aspects, the techniques described herein relate to a method, wherein the second device is different from the first device.

In some aspects, the techniques described herein relate to a system including: a processor; and a memory coupled to the processor, wherein the memory includes instructions that when executed by the processor cause the processor to: map input to a first task executable by a first task agent of a multi-agent application system, wherein the input is received at an orchestrator agent of the multi-agent application system via a first device; formulate a search using the input and the first task; execute the search on a second layer of a multi-layer memory accessible to the orchestrator agent, wherein the multi-layer memory includes a first layer and the second layer, the first layer stores communications between the orchestrator agent and a second task agent of the multi-agent application system, wherein the communications relate to user interactions with the multi-agent application system via the orchestrator agent, and wherein the second layer stores machine learning-based representations of the user interactions; extract, from results of the search, first cross-agent context data related to the input and the first task; route the first task and the first cross-agent context data to the first task agent; receive, from the first task agent, output generated via execution of the first task by the first task agent using the first cross-agent context data; and via a second device, provide a response to the input, wherein the response includes the output generated by the first task agent using the first cross-agent context data generated by the second task agent.

In some aspects, the techniques described herein relate to a system, wherein the first task is to detect anomalous accounts in a social network service, and wherein individual ones of the communications are associated with individual accounts of a social network service, and wherein the output generated by the first task agent includes detection of an anomalous one of the accounts and the output automatically triggers isolation of the anomalous one of the accounts.

In some aspects, the techniques described herein relate to a system, wherein the instructions, when executed by the processor, further cause the processor to map the input to the first task by: obtaining second cross-agent context data from the multi-layer memory; and determining the first task using the input and the second cross-agent context data.

In some aspects, the techniques described herein relate to a system, wherein the instructions, when executed by the processor, further cause the processor to: obtain a subset of the user interactions from the multi-layer memory; and via the second device, include the subset of the user interactions in the response.

In some aspects, the techniques described herein relate to a non-transitory computer readable medium including instructions, wherein when executed by a processor, the instructions cause the processor to: map input to a first task executable by a first task agent of a multi-agent application system, wherein the input is received at an orchestrator agent of the multi-agent application system via a first device; formulate a search using the input and the first task; execute the search on a second layer of a multi-layer memory accessible to the orchestrator agent, wherein the multi-layer memory includes a first layer and the second layer, the first layer stores communications between the orchestrator agent and a second task agent of the multi-agent application system, wherein the communications relate to user interactions with the multi-agent application system via the orchestrator agent, and wherein the second layer stores machine learning-based representations of the user interactions; extract, from results of the search, first cross-agent context data related to the input and the first task; route the first task and the first cross-agent context data to the first task agent; receive, from the first task agent, output generated via execution of the first task by the first task agent using the first cross-agent context data; and via a second device, provide a response to the input, wherein the response includes the output generated by the first task agent using the first cross-agent context data generated by the second task agent.

In some aspects, the techniques described herein relate to a non-transitory computer readable medium, wherein when executed by the processor, the instructions further cause the processor to: determine a presentation standard associated with the orchestrator agent; formulate the output generated by the first task agent according to the presentation standard; and include the formulated output in the response.

In some aspects, the techniques described herein relate to a non-transitory computer readable medium, wherein when executed by the processor, the instructions further cause the processor to: determine a performance threshold associated with the orchestrator agent; determine that performance of a third task agent of the multi-agent application system is below the performance threshold; and exclude output generated by the third task agent from the response.

In some aspects, the techniques described herein relate to a non-transitory computer readable medium, wherein when executed by the processor, the instructions further cause the processor to: route the first task to a plurality of task agents of the multi-agent application system including the first task agent; provide the first cross-agent context data to the plurality of task agents; receive, from respective task agents of the plurality of task agents, outputs generated via execution of the first task by the respective task agents using the first cross-agent context data; evaluate the respective outputs of the plurality of task agents using an evaluation threshold, the input, and the first task; and include a subset of the outputs that meet or exceed the evaluation threshold in the response.

In some aspects, the techniques described herein relate to a non-transitory computer readable medium, wherein when executed by the processor, the instructions further cause the processor to route the first task to the first task agent by: formulating a generative machine learning model (GMLM) prompt including the input, the first task, and the first cross-agent context data; providing the prompt to the GMLM; receiving output from the GMLM in response to the prompt; and using the output from the GMLM to select the first task agent from a plurality of task agents of the multi-agent application system to perform the first task. 21.

Clause 1. A method comprising: mapping input to a first task executable by a first task agent of a multi-agent application system, wherein the input is received at an orchestrator agent of the multi-agent application system via a first device; formulating a search using the input and the first task; executing the search on a second layer of a multi-layer memory accessible to the orchestrator agent, wherein the multi-layer memory comprises a first layer and the second layer, the first layer stores communications between the orchestrator agent and a second task agent of the multi-agent application system, wherein the communications relate to user interactions with the multi-agent application system via the orchestrator agent, and wherein the second layer stores machine learning-based representations of the user interactions; extracting, from results of the search, first cross-agent context data related to the input and the first task; routing the first task and the first cross-agent context data to the first task agent; receiving, from the first task agent, output generated via execution of the first task by the first task agent using the first cross-agent context data; and via a second device, providing a response to the input, wherein the response comprises the output generated by the first task agent using the first cross-agent context data generated by the second task agent.

Clause 2. The method of clause 1, wherein the first task is to detect anomalous accounts in a social network service, and wherein individual ones of the communications are associated with individual accounts of a social network service, and wherein the output generated by the first task agent comprises detection of an anomalous one of the accounts and the output automatically triggers isolation of the anomalous one of the accounts.

Clause 3. The method of clause 1 or clause 2, wherein mapping the input to the first task comprises: obtaining second cross-agent context data from the multi-layer memory; and determining the first task using the input and the second cross-agent context data.

Clause 4. The method of any of clauses 1-3, further comprising: obtaining a subset of the user interactions from the multi-layer memory; and via the second device, including the subset of the user interactions in the response.

Clause 5. The method of any of clauses 1-4, further comprising: obtaining a first subset of the user interactions with the multi-agent application system via a first channel operated via the orchestrator agent; obtaining a second subset of the user interactions with the multi-agent application system via a second channel; and storing machine learning-based representations of both the first subset and the second subset of the user interactions in the second layer of the multi-layer memory accessible to the orchestrator agent.

Clause 6. The method of any of clauses 1-5, further comprising: determining a presentation standard associated with the orchestrator agent; formulating the output generated by the first task agent according to the presentation standard; and including the formulated output in the response.

Clause 7. The method of any of clauses 1-6, further comprising: determining a performance threshold associated with the orchestrator agent; determining that performance of a third task agent of the multi-agent application system is below the performance threshold; and excluding output generated by the third task agent from the response.

Clause 8. The method of any of clauses 1-7, further comprising: routing the first task to a plurality of task agents of the multi-agent application system including the first task agent; providing the first cross-agent context data to the plurality of task agents; receiving, from respective task agents of the plurality of task agents, outputs generated via execution of the first task by the respective task agents using the first cross-agent context data; evaluating the respective outputs of the plurality of task agents using an evaluation threshold, the input, and the first task; and including a subset of the outputs that meet or exceed the evaluation threshold in the response.

Clause 9. The method of any of clauses 1-8, wherein the user interactions with the multi-agent application system via the orchestrator agent comprise, for a user, interaction streams across multiple session, multiple devices, or multiple sessions and multiple devices, and the method further comprises using the second memory layer to synchronize the interaction streams.

Clause 10. The method of any of clauses 1-9, wherein routing the first task to the first task agent comprises: formulating a generative machine learning model (GMLM) prompt including the input, the first task, and the first cross-agent context data; providing the prompt to the GMLM; receiving output from the GMLM in response to the prompt; and using the output from the GMLM to select the first task agent from a plurality of task agents of the multi-agent application system to perform the first task.

Clause 11. The method of any of clauses 1-10, wherein the second device is different from the first device.

Clause 12. A system comprising: a processor; and a memory coupled to the processor, wherein the memory comprises instructions that when executed by the processor cause the processor to: map input to a first task executable by a first task agent of a multi-agent application system, wherein the input is received at an orchestrator agent of the multi-agent application system via a first device; formulate a search using the input and the first task; execute the search on a second layer of a multi-layer memory accessible to the orchestrator agent, wherein the multi-layer memory comprises a first layer and the second layer, the first layer stores communications between the orchestrator agent and a second task agent of the multi-agent application system, wherein the communications relate to user interactions with the multi-agent application system via the orchestrator agent, and wherein the second layer stores machine learning-based representations of the user interactions; extract, from results of the search, first cross-agent context data related to the input and the first task; route the first task and the first cross-agent context data to the first task agent; receive, from the first task agent, output generated via execution of the first task by the first task agent using the first cross-agent context data; and via a second device, provide a response to the input, wherein the response comprises the output generated by the first task agent using the first cross-agent context data generated by the second task agent.

Clause 13. The system of clause 12, wherein the first task is to detect anomalous accounts in a social network service, and wherein individual ones of the communications are associated with individual accounts of a social network service, and wherein the output generated by the first task agent comprises detection of an anomalous one of the accounts and the output automatically triggers isolation of the anomalous one of the accounts.

Clause 14. The system of clause 12 or clause 13, wherein the instructions, when executed by the processor, further cause the processor to map the input to the first task by: obtaining second cross-agent context data from the multi-layer memory; and determining the first task using the input and the second cross-agent context data.

Clause 15. The system of any of clauses 12-14, wherein the instructions, when executed by the processor, further cause the processor to: obtain a subset of the user interactions from the multi-layer memory; and via the second device, include the subset of the user interactions in the response.

Clause 16. A non-transitory computer readable medium comprising instructions, wherein when executed by a processor, the instructions cause the processor to: map input to a first task executable by a first task agent of a multi-agent application system, wherein the input is received at an orchestrator agent of the multi-agent application system via a first device; formulate a search using the input and the first task; execute the search on a second layer of a multi-layer memory accessible to the orchestrator agent, wherein the multi-layer memory comprises a first layer and the second layer, the first layer stores communications between the orchestrator agent and a second task agent of the multi-agent application system, wherein the communications relate to user interactions with the multi-agent application system via the orchestrator agent, and wherein the second layer stores machine learning-based representations of the user interactions; extract, from results of the search, first cross-agent context data related to the input and the first task; route the first task and the first cross-agent context data to the first task agent; receive, from the first task agent, output generated via execution of the first task by the first task agent using the first cross-agent context data; and via a second device, provide a response to the input, wherein the response comprises the output generated by the first task agent using the first cross-agent context data generated by the second task agent.

Clause 17. The non-transitory computer readable medium of clause 16, wherein when executed by the processor, the instructions further cause the processor to: determine a presentation standard associated with the orchestrator agent; formulate the output generated by the first task agent according to the presentation standard; and include the formulated output in the response.

Clause 18. The non-transitory computer readable medium of clause 16 or clause 17, wherein when executed by the processor, the instructions further cause the processor to: determine a performance threshold associated with the orchestrator agent; determine that performance of a third task agent of the multi-agent application system is below the performance threshold; and exclude output generated by the third task agent from the response.

Clause 19. The non-transitory computer readable medium of any of clauses 16-18, wherein when executed by the processor, the instructions further cause the processor to: route the first task to a plurality of task agents of the multi-agent application system including the first task agent; provide the first cross-agent context data to the plurality of task agents; receive, from respective task agents of the plurality of task agents, outputs generated via execution of the first task by the respective task agents using the first cross-agent context data; evaluate the respective outputs of the plurality of task agents using an evaluation threshold, the input, and the first task; and include a subset of the outputs that meet or exceed the evaluation threshold in the response.

Clause 20. The non-transitory computer readable medium of any of clauses 16-19, wherein when executed by the processor, the instructions further cause the processor to route the first task to the first task agent by: formulating a generative machine learning model (GMLM) prompt including the input, the first task, and the first cross-agent context data; providing the prompt to the GMLM; receiving output from the GMLM in response to the prompt; and using the output from the GMLM to select the first task agent from a plurality of task agents of the multi-agent application system to perform the first task.

Aspects of the disclosure have been described with reference to specific examples. Various modifications are capable of being made to the described examples without departing from the spirit and scope of the disclosure reflected in the claims. The specification and drawings are illustrative and not restrictive.

What is claimed is:

1. A method comprising:
mapping input to a first task executable by a first task agent of a multi-agent application system, wherein the input is received at an orchestrator agent of the multi-agent application system via a first device;
formulating a search using the input and the first task;
executing the search on a second layer of a multi-layer memory accessible to the orchestrator agent, wherein the multi-layer memory comprises a first layer and the second layer, the first layer stores communications between the orchestrator agent and a second task agent of the multi-agent application system, wherein the communications relate to user interactions with the multi-agent application system via the orchestrator agent, and wherein the second layer stores machine learning-based representations of the user interactions;
extracting, from results of the search, first cross-agent context data related to the input and the first task;
routing the first task and the first cross-agent context data to the first task agent;
receiving, from the first task agent, output generated via execution of the first task by the first task agent using the first cross-agent context data; and
via a second device, providing a response to the input, wherein the response comprises the output generated by the first task agent using the first cross-agent context data generated by the second task agent.

2. The method of claim 1, wherein the first task is to detect anomalous accounts in a social network service, and wherein individual ones of the communications are associated with individual accounts of a social network service, and wherein the output generated by the first task agent comprises detection of an anomalous one of the accounts and the output automatically triggers isolation of the anomalous one of the accounts.

3. The method of claim 1, wherein mapping the input to the first task comprises:
obtaining second cross-agent context data from the multi-layer memory; and
determining the first task using the input and the second cross-agent context data.

4. The method of claim 1, further comprising:
obtaining a subset of the user interactions from the multi-layer memory; and
via the second device, including the subset of the user interactions in the response.

5. The method of claim 1, further comprising:
obtaining a first subset of the user interactions with the multi-agent application system via a first channel operated via the orchestrator agent;
obtaining a second subset of the user interactions with the multi-agent application system via a second channel; and
storing machine learning-based representations of both the first subset and the second subset of the user interactions in the second layer of the multi-layer memory accessible to the orchestrator agent.

6. The method of claim 1, further comprising:
determining a presentation standard associated with the orchestrator agent;
formulating the output generated by the first task agent according to the presentation standard; and
including the formulated output in the response.

7. The method of claim 1, further comprising:
determining a performance threshold associated with the orchestrator agent;
determining that performance of a third task agent of the multi-agent application system is below the performance threshold; and
excluding output generated by the third task agent from the response.

8. The method of claim 1, further comprising:
routing the first task to a plurality of task agents of the multi-agent application system including the first task agent;
providing the first cross-agent context data to the plurality of task agents;
receiving, from respective task agents of the plurality of task agents, outputs generated via execution of the first task by the respective task agents using the first cross-agent context data;
evaluating the respective outputs of the plurality of task agents using an evaluation threshold, the input, and the first task; and
including a subset of the outputs that meet or exceed the evaluation threshold in the response.

9. The method of claim 1, wherein the user interactions with the multi-agent application system via the orchestrator agent comprise, for a user, interaction streams across multiple session, multiple devices, or multiple sessions and multiple devices, and the method further comprises using the second memory layer to synchronize the interaction streams.

10. The method of claim 1, wherein routing the first task to the first task agent comprises:
formulating a generative machine learning model (GMLM) prompt including the input, the first task, and the first cross-agent context data;
providing the prompt to the GMLM;
receiving output from the GMLM in response to the prompt; and
using the output from the GMLM to select the first task agent from a plurality of task agents of the multi-agent application system to perform the first task.

11. The method of claim 1, wherein the second device is different from the first device.

12. A system comprising:
a processor; and
a memory coupled to the processor, wherein the memory comprises instructions that when executed by the processor cause the processor to:
map input to a first task executable by a first task agent of a multi-agent application system, wherein the input is received at an orchestrator agent of the multi-agent application system via a first device;
formulate a search using the input and the first task;
execute the search on a second layer of a multi-layer memory accessible to the orchestrator agent, wherein the multi-layer memory comprises a first layer and the second layer, the first layer stores communications between the orchestrator agent and a second task agent of the multi-agent application system, wherein the communications relate to user interactions with the multi-agent application system via the orchestrator agent, and wherein the second layer stores machine learning-based representations of the user interactions;
extract, from results of the search, first cross-agent context data related to the input and the first task;
route the first task and the first cross-agent context data to the first task agent;
receive, from the first task agent, output generated via execution of the first task by the first task agent using the first cross-agent context data; and
via a second device, provide a response to the input, wherein the response comprises the output generated by the first task agent using the first cross-agent context data generated by the second task agent.

13. The system of claim 12, wherein the first task is to detect anomalous accounts in a social network service, and wherein individual ones of the communications are associated with individual accounts of a social network service, and wherein the output generated by the first task agent comprises detection of an anomalous one of the accounts and the output automatically triggers isolation of the anomalous one of the accounts.

14. The system of claim 12, wherein the instructions, when executed by the processor, further cause the processor to map the input to the first task by:
obtaining second cross-agent context data from the multi-layer memory; and
determining the first task using the input and the second cross-agent context data.

15. The system of claim 12, wherein the instructions, when executed by the processor, further cause the processor to:
obtain a subset of the user interactions from the multi-layer memory; and
via the second device, include the subset of the user interactions in the response.

16. A non-transitory computer readable medium comprising instructions, wherein when executed by a processor, the instructions cause the processor to:
map input to a first task executable by a first task agent of a multi-agent application system, wherein the input is received at an orchestrator agent of the multi-agent application system via a first device;
formulate a search using the input and the first task;
execute the search on a second layer of a multi-layer memory accessible to the orchestrator agent, wherein the multi-layer memory comprises a first layer and the second layer, the first layer stores communications between the orchestrator agent and a second task agent of the multi-agent application system, wherein the communications relate to user interactions with the multi-agent application system via the orchestrator agent, and wherein the second layer stores machine learning-based representations of the user interactions;
extract, from results of the search, first cross-agent context data related to the input and the first task;
route the first task and the first cross-agent context data to the first task agent;
receive, from the first task agent, output generated via execution of the first task by the first task agent using the first cross-agent context data; and
via a second device, provide a response to the input, wherein the response comprises the output generated by the first task agent using the first cross-agent context data generated by the second task agent.

17. The non-transitory computer readable medium of claim 16, wherein when executed by the processor, the instructions further cause the processor to:
determine a presentation standard associated with the orchestrator agent;
formulate the output generated by the first task agent according to the presentation standard; and
include the formulated output in the response.

18. The non-transitory computer readable medium of claim 16, wherein when executed by the processor, the instructions further cause the processor to:
determine a performance threshold associated with the orchestrator agent;
determine that performance of a third task agent of the multi-agent application system is below the performance threshold; and
exclude output generated by the third task agent from the response.

19. The non-transitory computer readable medium of claim 16, wherein when executed by the processor, the instructions further cause the processor to:
route the first task to a plurality of task agents of the multi-agent application system including the first task agent;
provide the first cross-agent context data to the plurality of task agents;
receive, from respective task agents of the plurality of task agents, outputs generated via execution of the first task by the respective task agents using the first cross-agent context data;
evaluate the respective outputs of the plurality of task agents using an evaluation threshold, the input, and the first task; and
include a subset of the outputs that meet or exceed the evaluation threshold in the response.

20. The non-transitory computer readable medium of claim 16, wherein when executed by the processor, the instructions further cause the processor to route the first task to the first task agent by:
formulating a generative machine learning model (GMLM) prompt including the input, the first task, and the first cross-agent context data;
providing the prompt to the GMLM;
receiving output from the GMLM in response to the prompt; and
using the output from the GMLM to select the first task agent from a plurality of task agents of the multi-agent application system to perform the first task.
